(19) United States
(12) Patent Application Publication
(10) Pub. No.: US 2022/0279558 A1
(43) Pub. Date: Sep. 1, 2022

(54) TERMINAL DEVICE, NETWORK NODE AND METHOD FOR FACILITATING TRANSMISSION OF LOGICAL CHANNELS OVER SIDELINK

(71) Applicant: Telefonaktiebolaget LM Ericsson (publ), Stockholm (SE)

(72) Inventors: Zhang Zhang, Beijing (CN); Congchi Zhang, Shanghai (CN); Antonino Orsino, Kirkkonummi (FI)

(21) Appl. No.: 17/632,817

(22) PCT Filed: Aug. 4, 2020
(86) PCT No.: PCT/CN2020/106788

§ 371 Date: Feb. 4, 2022

(30) Foreign Application Priority Data
Aug. 5, 2019 (CN) PCT/CN2019/099311

(51) Int. Cl. H04W 72/12

(52) U.S. Cl. CPC H04W 72/1278; H04W 72/1247; H04W 92/18

(57) ABSTRACT

The present disclosure provides a method in a terminal device. The method includes: determining whether each of a plurality of Logical Channels (LCHs) to be transmitted over a sidelink is in a starved state; and selecting at least one of destinations associated with the plurality of LCHs based on whether at least one of the plurality of LCHs is determined to be in the starved state.

### TECHNICAL FIELD

The present disclosure relates to wireless communication, and more particularly, to, a terminal device, and a network node and methods for facilitating transmission of Logical Channels (LCHs) over sidelink.

### BACKGROUND

In the 3^{rd} Generation Partnership Project (3GPP) Release 14 (Rel-14) and Release 15 (Rel-15), extensions for device-to-device communications support Vehicle-to-Anything (V2X) communications, including any combination of direct communications between vehicles, pedestrians and network infrastructures. V2X communications may carry safety or non-safety information, and V2X applications and services may be associated with specific requirements in terms of e.g., latency, reliability, data rates, etc. V2X communications may take advantage of a network infrastructure (when available), but at least basic V2X connectivity should be possible even in case of no network coverage. Providing a Long Term Evolution (LTE) based V2X interface may be advantageous economically due to the LTE's economy of scale and capability of providing a tighter integration between communications with network infrastructures (Vehicle-to-Infrastructure/Network, or V2I/N), pedestrians (Vehicle-to-Pedestrian, or V2P) and other vehicles (Vehicle-to-Vehicle, or V2V), as compared to using a dedicated V2X technology (e.g., Institute of Electrical and Electronic Engineers (IEEE) 802.11p). Here, V2V covers LTE-based communications between vehicles, either via a cellular interface (known as Uu) or via a sidelink interface (known as PC5). V2P covers LTE-based communications between a vehicle and a device carried by an individual (e.g., a handheld terminal carried by a pedestrian, cyclist, driver or passenger), via either a Uu or sidelink (PC5) interface. V2I/N covers LTE-based communications between a vehicle and a roadside unit (RSU) or a network. An RSU is a transportation infrastructure entity (e.g., an entity transmitting speed notifications) that communicates with V2X capable UEs via sidelink (PC5) or Uu. V2N communications are performed via a Uu interface.

In the 5th Generation (5G) or New Radio (NR), the 3GPP Service and System Aspects 1 (SA1) working group has completed new service requirements for future V2X services in Study on Enhancement of 3GPP support for V2X services (FS_eV2X). The SA1 working group has identified 25 use cases for advanced V2X services which will be used in 5G (i.e., in LTE and NR). These use cases are categorized into four use case groups: vehicles platooning, extended sensors, advanced driving and remote driving. Direct unicast transmission over sidelink will be needed in some use cases such as platooning, cooperative driving, dynamic ride sharing, etc. For these advanced applications, the expected requirements on data rate, capacity, reliability, latency, communication range and speed will be more stringent. The consolidated requirements for each use case group are captured in 3GPP Technical Report (TR) 22.886 V16.2.0.

There are two modes of resource allocation procedures for V2X on sidelink: network controlled resource allocation (referred to as “mode 3” in LTE or “mode 1” in NR) and autonomous resource allocation (referred to as “mode 4” in LTE or “mode 2” in NR). In either mode, transmission resources are selected from a resource pool which is predefined or configured by a network device. In the network controlled resource allocation, sidelink radio resources for data transmission are scheduled or allocated by a network device. A terminal device, or User Equipment (UE), sends a sidelink Buffer Status Report (BSR) to the network device, indicating sidelink data available for transmission in a sidelink buffer associated with a Medium Access Control (MAC) entity, and then the network device signals a resource allocation to the UE via Downlink Control Information (DCI). In the autonomous resource allocation, a UE autonomously decides which radio resources to use for sidelink transmission by means of e.g., channel sensing. In both resource allocation modes, Sidelink Control Information (SCI) is transmitted on a Physical Sidelink Control Channel (PSCCH) to indicate the sidelink resources allocated for Physical Sidelink Shared Channel (PSSCH). The SCI indicates allocated resources, a modulation and coding scheme, Hybrid Automatic Repeat reQuest (HARQ) related information, an intention to reserve the same resources for a future data transmission, etc. Moreover, for unicast and multicast, the SCI can further include a Layer-1 destination identifier and potentially a source identifier as well.

In channel sensing, a UE (referred to as sensing UE) decodes SCI transmitted from each nearby UE, and determines from the SCI a resource on which a PSSCH is transmitted by the nearby UE and the highest priority, denoted as P1, among LCH priorities of respective sidelink LCHs in a MAC Protocol Data Unit (PDU) transmitted over the PSSCH. The highest priority is indicated in a priority field in the SCI. The sensing UE also determines the highest priority, denoted as P0, among LCH priorities of respective sidelink LCHs in a MAC PDU to be transmitted by the sensing UE over the PSSCH. The sensing UE measures a Reference Signal Received Power (RSRP) over the PSSCH and compares it with a threshold. The resource is regarded unoccupied and available for transmission if the measured RSRP over the resource is lower than a threshold, which is set by taking both P0 and P1 into account, such that the threshold is set higher if P0 is higher than P1, or vice versa. In this way, a resource is more likely to be regarded unoccupied and available for transmission by a sensing UE having an LCH with a higher priority to transmit. For details of the channel sensing procedure, reference can be made to 3GPP Technical Specification (TS) 36.213 V15.6.0.

A sidelink Logical Channel Prioritization (LCP) procedure is applied when a new sidelink transmission is to be performed. Each sidelink LCH has an associated priority, which can be Proximity Service (Prose) Per Packet Priority (PPPP) in LTE, and optionally an associated ProSe Per Packet Reliability (PPPR). In NR, an LCH's associated priority and reliability may be derived from a Quality of Service (QoS) profile of a sidelink radio bearer. When a MAC entity allocates resources to sidelink LCHs having data available for transmission, it will first select a Layer-2 destination based on the highest priority of all the sidelink LCHs associated with each Layer-2 destination. The Layer-2 destination associated with the LCH having the highest priority will be selected. Then, sidelink LCHs associated with the selected Layer-2 destination will be scheduled in descending order of their priorities, until either the data for the LCHs or the sidelink grant is exhausted, whichever comes first.

If there are simultaneous uplink and sidelink transmissions, prioritization between uplink and sidelink transmissions is needed. In LTE, if an uplink transmission is not for Message 3 (Msg3) or not prioritized by an upper layer, the sidelink transmission will be prioritized if the value of the highest priority of the sidelink LCH(s) in a MAC PDU is lower than a network configured threshold thresSL-TxPrioritization (a lower priority value corresponding to a higher priority). In NR, it has been agreed that the prioritization will consider both uplink and sidelink QoS requirements.

If there are simultaneous sidelink transmissions on different frequencies and/or Radio Access Technologies (RATs), and their total transmission power exceeds a maximum allowed transmission power, a UE can decrease the transmission power of the sidelink transmission having the lowest priority, or even drop the transmission. The procedure can be repeated, if necessary, until the maximum allowed transmission power is met.

For details of the LCP procedure, reference can be made to 3GPP TS 36.321 V15.6.0.

### SUMMARY

In an LCP procedure for uplink transmissions, a starvation avoidance mechanism is introduced to avoid that all resources are given to high priority channels/services and low priority channels/services have no chance to be scheduled. In doing so, a variable Bj is maintained for each LCH j (where j is an LCH index) and initially set to zero. Bj is incremented by a product PBRj×T before every instance of the LCP procedure, where PBRj is a prioritized bit rate for the LCH j and T is the time elapsed since Bj was last incremented. If Bj is greater than a bucket size (i.e., PBRj×bucketSizeDuration (BSD)), Bj is set to the bucket size. Bj is updated such that it is up to date at the time when a grant is processed by the LCP procedure. When a new uplink transmission is to be performed, resources will only be allocated to LCHs with Bj>0 in a descending order of their priorities, and for each LCH having been allocated with resources, Bj is decremented by a total size of MAC Service Data Units (SDUs) served to LCH j (Bj can be negative after this step). If any resource remains, all the LCHs can be scheduled in a strict descending order of their priorities, regardless of the value of Bj, until either the data for the LCHs or the uplink grant is exhausted, whichever comes first. For further details of this procedure, reference can be made to 3GPP TS 36.321 V15.6.0 and TS 38.321 V15.6.0.

A starvation avoidance mechanism can be applied to the sidelink LCP procedure. For uplink transmission, the LCP procedure is used to decide to which LCH(s) the resources are to be allocated. However, for sidelink transmissions, the LCP procedure may also be used in destination selection, channel sensing, uplink-sidelink prioritization, and/or sidelink-sidelink prioritization. Thus, it would not be sufficient to only consider starvation avoidance in deciding resource allocation among sidelink LCHs. For the Layer-2 destination selection as an example, if a UE selects a destination having the highest priority without considering any starvation situation of LCHs, there may be a case where all sidelink LCHs associated with the selected destination are not starved (e.g., having corresponding Bj≤0), while some sidelink LCHs associated with another destination may be starved (e.g., having corresponding Bj>0).

It is an object of the present disclosure to provide a terminal device, and a network node and methods therein, capable of avoiding, or at least mitigating, starvation of sidelink LCHs in one or more sidelink related procedures.

According to a first aspect of the present disclosure, a method in a terminal device is provided. The method includes: determining whether each of a plurality of LCHs to be transmitted over a sidelink is in a starved state; and selecting at least one of destinations associated with the plurality of LCHs based on whether at least one of the plurality of LCHs is determined to be in the starved state. In other words, the method includes: determining, for each of a plurality of Logical Channels, LCHs, to be transmitted over a sidelink, whether the LCH is in a starved state; and selecting at least one of destinations associated with the plurality of LCHs based on whether at least one of the plurality of LCHs is determined to be in the starved state.

According to a second aspect of the present disclosure, a method in a terminal device is provided. The method includes: determining whether each of a plurality of LCHs is in a starved state, the plurality of LCHs including a first set of LCHs for initial transmission over a sidelink and a second set of LCHs for retransmission over the sikelink; and determining whether a sidelink grant is to be used for the initial transmission or the retransmission based on whether each of the first set and the second set contains at least one LCH that is in the starved state.

According to a third aspect of the present disclosure, a method in a terminal device is provided. The method includes: determining whether each of a plurality of LCHs to be transmitted over a sidelink is in a starved state; and transmitting, when at least one of the plurality of LCHs is determined to be in the starved state, SCI indicating a highest LCH priority among at least one LCH priority of the at least one LCH.

According to a fourth aspect of the present disclosure, a method in a terminal device is provided. The method includes: determining whether each of a plurality of LCHs to be transmitted over a sidelink is in a starved state; and transmitting SCI indicating: a first priority which, when at least one of the plurality of LCHs is determined to be in the starved state, is a highest LCH priority among at least one LCH priority of the at least one LCH determined to be in the starved state; and a second priority which, when at least one of the plurality of LCHs is determined not to be in the starved state, is a highest LCH priority among at least one LCH priority of the at least one LCH determined not to be in the starved state.

According to a fifth aspect of the present disclosure, a method in a terminal device is provided. The method includes: determining whether each of a plurality of LCHs to be transmitted over a sidelink is in a starved state; receiving, from another terminal device, SCI indicating at least a priority; determining whether the indicated priority is associated with an LCH in the starved state; and performing, when at least one of the plurality of LCHs is determined to be in the starved state and the indicated priority is associated with an LCH in the starved state, sidelink channel sensing based on a highest LCH priority among at least one LCH priority of the at least one LCH determined to be in the starved state and the indicated priority.

According to a sixth aspect of the present disclosure, a method in a terminal device is provided. The method includes: determining whether each LCH in a first set of LCHs to be transmitted over a sidelink and a second set of LCHs to be transmitted over an uplink is in a starved state; and prioritizing one of the first set and the second set over the other based on whether each of the first set and the second set contains at least one LCH that is in the starved state.

According to a seventh aspect of the present disclosure, a method in a terminal device is provided. The method includes: determining whether each of a plurality of LCHs to be transmitted over a sidelink is in a starved state; and determining that a total sidelink transmission power exceeds a maximum allowed transmission power of the terminal device; and decreasing, when a first set of the plurality of LCHs is determined to be in the starved state and a second set of the plurality of LCHs is determined not to be in the starved state, a transmission power of at least one LCH in the second set.

According to an eighth aspect of the present disclosure, a terminal device is provided. The terminal device includes a processor and a memory. The memory contains instructions executable by the processor whereby the terminal device is operative to perform the method according to any of the above first to eighth aspects.

According to a ninth aspect of the present disclosure, a computer readable storage medium is provided. The computer readable storage medium has computer program instructions stored thereon. The computer program instructions, when executed by a processor in a terminal device, cause the terminal device to perform the method according to any of the above first to eighth aspects.

According to a tenth aspect of the present disclosure, a method in a network node is provided. The method includes: determining a configuration for a terminal device to select at least one of destinations associated with a plurality of LCHs to be transmitted over a sidelink based on whether at least one of the plurality of LCHs is in a starved state; and transmitting the configuration to the terminal device.

According to an eleventh aspect of the present disclosure, a method in a network node is provided. The method includes: determining a configuration for a terminal device to determine whether a sidelink grant is to be used for an initial transmission or a retransmission based on whether each of a first set of LCHs and a second set of LCHs contains at least one LCH that is in a starved state; and transmitting the configuration to the terminal device.

According to a twelfth aspect of the present disclosure, a method in a network node is provided. The method includes: determining a configuration for a terminal device to transmit, when at least one of a plurality of LCHs in a starved state, SCI indicating a highest LCH priority among at least one LCH priority of the at least one LCH; and transmitting the configuration to the terminal device.

According to a thirteenth aspect of the present disclosure, a method in a network node is provided. The method includes: determining a configuration for a terminal device to transmit SCI indicating: a first priority which, when at least one of a plurality of LCHs to be transmitted over a sidelink is in a starved state, is a highest LCH priority among at least one LCH priority of the at least one LCH in the starved state, and a second priority which, when at least one of the plurality of LCHs is not in the starved state, is a highest LCH priority among at least one LCH priority of the at least one LCH not in the starved state; and transmitting the configuration to the terminal device.

According to a fourteenth aspect of the present disclosure, a method in a network node is provided. The method includes: determining a configuration for a terminal device to perform sidelink channel sensing based on whether at least one of a plurality of LCHs to be transmitted over a sidelink is in the starved state and whether a priority indicated in SCI received from another terminal device is associated with an LCH in a starved state; and transmitting the configuration to the terminal device.

According to a fifteenth aspect of the present disclosure, a method in a network node is provided. The method includes: determining a configuration for a terminal device to prioritize one of a first set of LCHs and a second set of LCHs over the other based on whether each of the first set and the second set contains at least one LCH that is in a starved state, the first set of LCHs to be transmitted over a sidelink and the second set of LCHs to be transmitted over an uplink; and transmitting the configuration to the terminal device.

According to a sixteenth aspect of the present disclosure, a method in a network node is provided. The method includes: determining a configuration for a terminal device to decrease, when a total sidelink transmission power exceeds a maximum allowed transmission power of the terminal device and when a first set of a plurality of LCHs to be transmitted over a sidelink is in a starved state and a second set of the plurality of LCHs is not in the starved state, a transmission power of at least one LCH in the second set; and transmitting the configuration to the terminal device.

According to a seventeenth aspect of the present disclosure, a network node is provided. The network node includes a processor and a memory. The memory contains instructions executable by the processor whereby the network node is operative to perform the method according to any of the above tenth to sixteenth aspects.

According to an eighteenth aspect of the present disclosure, a computer readable storage medium is provided. The computer readable storage medium has computer program instructions stored thereon. The computer program instructions, when executed by a processor in a network node, cause the network node to perform the method according to any of the above tenth to sixteenth aspects.

According to a nineteenth aspect of the present disclosure, a communication system is provided. The communication system includes a host computer including: processing circuitry configured to provide user data; and a communication interface configured to forward the user data to a cellular network for transmission to a UE. The cellular network includes a base station having a radio interface and processing circuitry. The base station's processing circuitry is configured to perform the method according to any of the above tenth to sixteenth aspects.

In an embodiment, the communication system can further include the base station.

In an embodiment, the communication system can further include the UE. The UE is configured to communicate with the base station.

In an embodiment, the processing circuitry of the host computer can be configured to execute a host application, thereby providing the user data. The UE can include processing circuitry configured to execute a client application associated with the host application.

According to a twentieth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The base station can perform the method according to any of the above tenth to sixteenth aspects.

In an embodiment, the method further can include: at the base station, transmitting the user data.

In an embodiment, the user data can be provided at the host computer by executing a host application. The method can further include: at the UE, executing a client application associated with the host application.

According to a twenty-first aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform the method according to any of the above first to seventh aspects.

In an embodiment, the communication system can further include the UE.

In an embodiment, the cellular network can further include a base station configured to communicate with the UE.

In an embodiment, the processing circuitry of the host computer can be configured to execute a host application, thereby providing the user data. The UE's processing circuitry can be configured to execute a client application associated with the host application.

According to a twenty-second aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station.

The UE can perform the method according to any of the above first to seventh aspects.

In an embodiment, the method can further include: at the UE, receiving the user data from the base station.

According to a twenty-third aspect of the present disclosure, a communication system is provided. The communication system includes a host computer including: a communication interface configured to receive user data originating from a transmission from a UE to a base station. The UE includes a radio interface and processing circuitry. The UE's processing circuitry is configured to: perform the method according to any of the above first to seventh aspects.

In an embodiment, the communication system can further include the UE.

In an embodiment, the communication system can further include the base station. The base station can include a radio interface configured to communicate with the UE and a communication interface configured to forward to the host computer the user data carried by a transmission from the UE to the base station.

In an embodiment, the processing circuitry of the host computer can be configured to execute a host application. The UE's processing circuitry can be configured to execute a client application associated with the host application, thereby providing the user data.

In an embodiment, the processing circuitry of the host computer can be configured to execute a host application, thereby providing request data. The UE's processing circuitry can be configured to execute a client application associated with the host application, thereby providing the user data in response to the request data.

According to a twenty-fourth aspect of the present disclosure, a method is provided. The method is implemented in a communication system including a host computer, a base station and a UE. The method includes: at the host computer, receiving user data transmitted to the base station from the UE. The UE can perform the method according to any of the above first to seventh aspects.

In an embodiment, the method can further include: at the UE, providing the user data to the base station.

In an embodiment, the method can further include: at the UE, executing a client application, thereby providing the user data to be transmitted; and at the host computer, executing a host application associated with the client application.

In an embodiment, the method can further include: at the UE, executing a client application; and at the UE, receiving input data to the client application, the input data being provided at the host computer by executing a host application associated with the client application. The user data to be transmitted is provided by the client application in response to the input data.

According to a twenty-fifth aspect of the present disclosure, a communication system is provided. The communication system includes a host computer including a communication interface configured to receive user data originating from a transmission from a UE to a base station. The base station includes a radio interface and processing circuitry. The base station's processing circuitry is configured to perform the method according to any of the above tenth to sixteenth aspects.

In an embodiment, the communication system can further include the base station.

In an embodiment, the communication system can further include the UE. The UE can be configured to communicate with the base station.

In an embodiment, the processing circuitry of the host computer can be configured to execute a host application; the UE can be configured to execute a client application associated with the host application, thereby providing the user data to be received by the host computer.

According to a twenty-sixth aspect of the present disclosure, a method is provided. The method is implemented in a communication system including a host computer, a base station and a UE. The method includes: at the host computer, receiving, from the base station, user data originating from a transmission which the base station has received from the UE. The base station can perform the method according to any of the above tenth to sixteenth aspects.

In an embodiment, the method can further include: at the base station, receiving the user data from the UE.

In an embodiment, the method can further include: at the base station, initiating a transmission of the received user data to the host computer.

With the solutions according to the embodiments of the present disclosure, starvation of LCHs can be avoided, or at least mitigated, in sidelink related procedures such as destination selection, channel sensing, uplink-sidelink prioritization, and/or sidelink-sidelink prioritization.

### BRIEF DESCRIPTION OF THE DRAWINGS

The above and other objects, features and advantages will be more apparent from the following description of embodiments with reference to the figures, in which:

FIG. 1 is a flowchart illustrating a method in a terminal device according to an embodiment of the present disclosure;

FIG. 2 is a flowchart illustrating a method in a terminal device according to another embodiment of the present disclosure;

FIG. 3 is a flowchart illustrating a method in a terminal device according to another embodiment of the present disclosure;

FIG. 4 is a flowchart illustrating a method in a terminal device according to another embodiment of the present disclosure;

FIG. 5 is a flowchart illustrating a method in a terminal device according to another embodiment of the present disclosure;

FIG. 6 is a flowchart illustrating a method in a terminal device according to another embodiment of the present disclosure;

FIG. 7 is a flowchart illustrating a method in a terminal device according to another embodiment of the present disclosure;

FIG. 8 is a flowchart illustrating a method in a network node according to an embodiment of the present disclosure;

FIG. 9 is a flowchart illustrating a method in a network node according to another embodiment of the present disclosure;

FIG. 10 is a flowchart illustrating a method in a network node according to another embodiment of the present disclosure;

FIG. 11 is a flowchart illustrating a method in a network node according to another embodiment of the present disclosure;

FIG. 12 is a flowchart illustrating a method in a network node according to another embodiment of the present disclosure;

FIG. 13 is a flowchart illustrating a method in a network node according to another embodiment of the present disclosure;

FIG. 14 is a flowchart illustrating a method in a network node according to another embodiment of the present disclosure;

FIG. 15 is a block diagram of a terminal device according to an embodiment of the present disclosure;

FIG. 16 is a block diagram of a terminal device according to another embodiment of the present disclosure;

FIG. 17 is a block diagram of a network node according to an embodiment of the present disclosure;

FIG. 18 is a block diagram of a network node according to another embodiment of the present disclosure;

FIG. 19 schematically illustrates a telecommunication network connected via an intermediate network to a host computer;

FIG. 20 is a generalized block diagram of a host computer communicating via a base station with a user equipment over a partially wireless connection; and

FIGS. 21 to 24 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or (next) generation NodeB (gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation. For example, a terminal device may be a V2X capable UE.

As used herein, a downlink transmission refers to a transmission from the network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

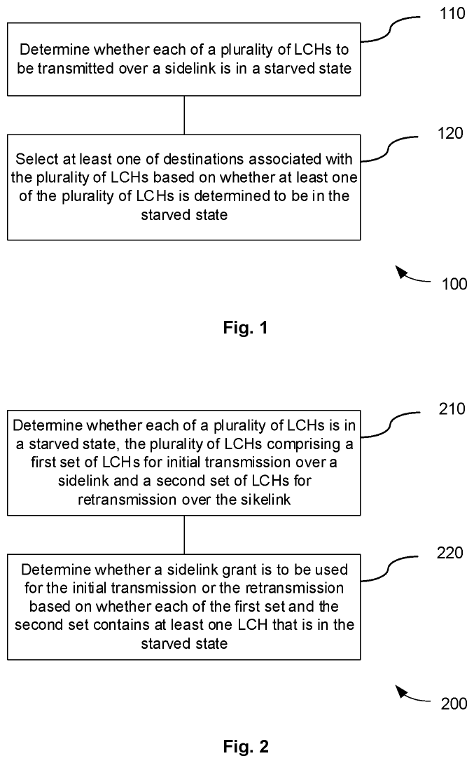

FIG. 1 is a flowchart illustrating a method 100 according to an embodiment of the present disclosure. The method 100 can be performed in a terminal device, e.g., a UE.

At block 110, it is determined whether each of a plurality of LCHs to be transmitted over a sidelink is in a starved state. In other words, for each of a plurality of LCHs to be transmitted over a sidelink, it is determined whether the LCH is in a starved state.

In an example, the LCH with LCH index j can be determined to be in the starved state when a variable Bj is greater than zero. Bj is maintained for the LCH with LCH index j and initially set to zero; Bj is incremented by product prioritisedBitRate(PBR)×T before every instance of a Logical Channel Prioritization, LCP, procedure, where prioritisedBitRate(PBR) is a prioritized bit rate and T is time elapsed since Bj was last incremented, and if Bj is greater than a bucket size, Bj is set to the bucket size.

In an example, in the block 110, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. Different predefined data rates and/or different calculations of scheduled data rates can be used for different LCHs.

As an illustrative example, the variable Bj as discussed above can be used here for determining whether an LCH is in the starved state. For example, an LCH j can be determined to be in the starved state when Bj 0, which means that the current scheduled data rate of the LCH j is lower than or equal to the predefined data rate for the LCH (e.g., the predefined data rate can be PBRj as described above). Alternatively, an LCH j can be determined to be in the starved state when an average of Bj over a last time period (e.g., last M seconds, where M is a configurable integer) is larger than or equal to 0. Alternatively, an LCH j can be determined to be in the starved state when an average of last N updated values of Bj is larger than or equal to 0, where N is a configurable integer. Alternatively, an LCH j can be determined to be in the starved state when each of P out of Q updated values of Bj is larger than or equal to 0, where P and Q are configurable integers.

At block 120, at least one of destinations associated with the plurality of LCHs is selected based on whether at least one of the plurality of LCHs is determined to be in the starved state.

In particular, in the block 120, when at least one of the plurality of LCHs is determined to be in the starved state, a destination having a highest destination priority can be selected from at least one destination associated with the at least one LCH. Here, a destination priority of each of the at least one destination is a highest LCH priority among LCH priorities of the respective LCHs associated with that destination that are determined to be in the starved state. That is, when at least one LCH is determined to be in the starved state, the selection is made only from the destinations associated with the at least one LCH and then the comparison of their destination priorities is made based only on the LCH priorities of the LCHs determined to be in the starved state.

On the other hand, when none of the plurality of LCHs is determined to be in the starved state, a destination having a highest destination priority can be selected from destinations associated with the plurality of LCHs. A destination priority of each destination here can be a highest LCH priority among LCH priorities of the respective LCHs associated with that destination.

Here, the method 100 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

FIG. 2 is a flowchart illustrating a method 200 according to an embodiment of the present disclosure. The method 200 can be performed in a terminal device, e.g., a UE.

At block 210, it is determined whether each of a plurality of LCHs is in a starved state, the plurality of LCHs including a first set of LCHs for initial transmission over a sidelink and a second set of LCHs for retransmission over the sikelink.

In an example, in the block 210, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here.

At block 220, it is determined whether a sidelink grant is to be used for the initial transmission or the retransmission based on whether each of the first set and the second set contains at least one LCH that is in the starved state.

In an example, in the block 220, when only the first set contains at least one LCH that is in the starved state, the sidelink grant can be determined to be used for the initial transmission. When only the second set contains at least one LCH that is in the starved state, the sidelink grant can be determined to be used for the retransmission.

In another example, in the block 220, when the first set contains a first subset of LCHs each in the starved state and the second set contains a second subset of LCHs each in the starved state, the sidelink grant can be determined to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In yet another example, in the block 220, when the first set contains no LCH in the starved state and the second set contains no LCH in the starved state, the sidelink grant can be determined to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

Here, the method 200 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

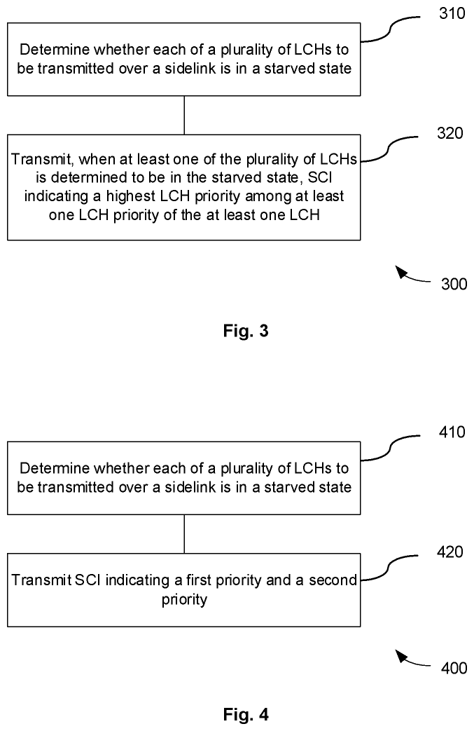

FIG. 3 is a flowchart illustrating a method 300 according to an embodiment of the present disclosure. The method 300 can be performed in a terminal device, e.g., a UE.

At block 310, it is determined whether each of a plurality of LCHs to be transmitted over a sidelink is in a starved state.

In an example, in the block 310, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here.

At block 320, when at least one of the plurality of LCHs is determined to be in the starved state, Sidelink Control Information (SCI) is transmitted, e.g., over PSCCH, indicating a highest LCH priority among at least one LCH priority of the at least one LCH.

In an example, the SCI can further indicate presence of the at least one LCH in the starved state.

In another example, when none of the plurality of LCHs is determined to be in the starved state, SCI is transmitted, e.g., over PSCCH, indicating a highest LCH priority among LCH priorities of the plurality of LCHs and absence of any LCH in the starved state.

Here, the method 300 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

FIG. 4 is a flowchart illustrating a method 400 according to an embodiment of the present disclosure. The method 400 can be performed in a terminal device, e.g., a UE.

At block 410, it is determined whether each of a plurality of LCHs to be transmitted over a sidelink is in a starved state.

In an example, in the block 410, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here.

At block 420, Sidelink Control Information (SCI) is transmitted, e.g., over PSCCH, indicating a first priority and a second priority. When at least one of the plurality of LCHs is determined to be in the starved state, the first priority is a highest LCH priority among at least one LCH priority of the at least one LCH determined to be in the starved state. When at least one of the plurality of LCHs is determined not to be in the starved state, the second priority is a highest LCH priority among at least one LCH priority of the at least one LCH determined not to be in the starved state.

In an example, when none of the plurality of LCHs is determined to be in the starved state, the first priority can be set to a first priority value indicating that none of the plurality of LCHs is determined to be in the starved state. The first priority value can be a priority value corresponding to the lowest allowable priority. When all of the plurality of LCHs are determined to be in the starved state, the second priority can be set to a second priority value indicating that all of the plurality of LCHs are determined to be in the starved state. The second priority value can be a priority value corresponding to the lowest allowable priority.

Here, the method 400 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

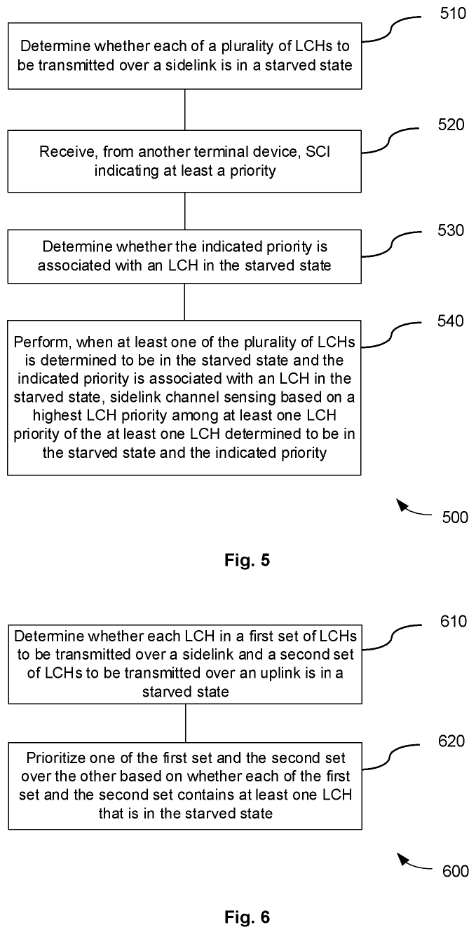

FIG. 5 is a flowchart illustrating a method 500 according to an embodiment of the present disclosure. The method 500 can be performed in a terminal device, e.g., a UE.

At block 510, it is determined whether each of a plurality of LCHs to be transmitted over a sidelink is in a starved state.

In an example, in the block 510, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here.

At block 520, Sidelink Control Information (SCI) indicating at least a priority is received from another terminal device, e.g., over PSCCH.

At block 530, it is determined whether the indicated priority is associated with an LCH in the starved state. For example, the SCI received in the block 520 may indicate presence of an LCH in the starved state, as described above in connection with the method 300 shown in FIG. 3, or may indicate a priority (first priority) associated with an LCH in the starved state, as described above in connection with the method 400 shown in FIG. 4. In either case, the terminal device can determine that the indicated priority is associated with an LCH in the starved state. On the other hand, the SCI received in the block 520 may indicate absence of any LCH in the starved state, as described above in connection with the method 300 shown in FIG. 3, or may indicate a priority (first priority) set to a predefined priority value (a first priority value) indicating absence of any LCH in the starved state, as described above in connection with the method 400 shown in FIG. 4. In either case, the terminal device can determine that the indicated priority is not associated with an LCH in the starved state.

At block 540, when at least one of the plurality of LCHs is determined to be in the starved state and the indicated priority is associated with an LCH in the starved state, sidelink channel sensing is performed based on a highest LCH priority among at least one LCH priority of the at least one LCH determined to be in the starved state and the indicated priority. For example, assuming that the indicated priority is P1 and the highest LCH priority among at least one LCH priority of the at least one LCH determined to be in the starved state is P0, in the channel sensing, the threshold for determining whether a resource is unoccupied and available for transmission is set based on P1 and P0.

In an example, when none of the plurality of LCHs is determined to be in the starved state and the indicated priority is associated with an LCH in the starved state, sidelink channel sensing can be performed based on a priority lower than a predefined priority and the indicated priority. For example, assuming that the indicated priority is P1 and the highest LCH priority among the LCH priorities of the plurality of LCHs is P2 (none of the plurality of LCHs is determined to be in the starved state), in the channel sensing, the threshold for determining whether a resource is unoccupied and available for transmission is set based on P1 and PL (instead of P2), where PL is a predefined low priority, e.g., the lowest allowable priority, for the purpose of starvation avoidance.

In another example, when it is determined that the indicated priority is not associated with an LCH in the starved state and that the SCI indicates no priority associated with an LCH in the starved state and when at least one of the plurality of LCHs is determined to be in the starved state, sidelink channel sensing is performed based on a highest LCH priority among at least one LCH priority of the at least one LCH determined to be in the starved state and a priority lower than a predefined priority. For example, assuming that the indicated priority is P1 and the highest LCH priority among at least one LCH priority of the at least one LCH determined to be in the starved state is P0, in the channel sensing, the threshold for determining whether a resource is unoccupied and available for transmission is set based on PL (instead of P1) and P0, where PL is a predefined low priority, e.g., the lowest allowable priority, for the purpose of starvation avoidance.

Here, the method 500 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

FIG. 6 is a flowchart illustrating a method 600 according to an embodiment of the present disclosure. The method 600 can be performed in a terminal device, e.g., a UE.

At block 610, it is determined whether each LCH in a first set of LCHs to be transmitted over a sidelink and a second set of LCHs to be transmitted over an uplink is in a starved state.

In an example, in the block 610, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here. Different predefined data rates and/or different calculations of scheduled data rates can be used for the LCHs over the sidelink and the LCHs over the uplink.

At block 620, one of the first set and the second set is prioritized over the other based on whether each of the first set and the second set contains at least one LCH that is in the starved state.

In an example, in the block 620, when a first subset of the first set of LCHs and a second subset of the second set of LCHs are determined to be in the starved state, one of the first set and the second set can be prioritized over the other based on a highest LCH priority among LCH priorities of the respective LCHs in the first subset and a highest LCH priority among LCH priorities of the respective LCHs in the second subset. For example, when the highest LCH priority among the LCH priorities of the respective LCHs in the first subset is higher than the highest LCH priority among the LCH priorities of the respective LCHs in the second subset, the first set can be prioritized over the second set, or vice versa.

In another example, in the block 620, when none of the first set of LCHs and the second set of LCHs is determined to be in the starved state, one of the first set and the second set can be prioritized over the other based on a highest LCH priority among LCH priorities of the respective LCHs in the first set and a highest LCH priority among LCH priorities of the respective LCHs in the second set. For example, when a highest LCH priority among LCH priorities of the respective LCHs in the first set is higher than the highest LCH priority among LCH priorities of the respective LCHs in the second set, the first set can be prioritized over the second set, or vice versa.

In yet another example, in the block 620, the first set can be prioritized over the second set when at least one of the first set of LCHs is determined to be in the starved state while none of the second set of LCHs is determined to be in the starved state, or the second set can be prioritized over the first set, when at least one of the second set of LCHs is determined to be in the starved state while none of the first set of LCHs is determined to be in the starved state.

Here, as an example, the first set is “prioritized” over the second set may mean that, when a total transmission power exceeds a maximum allowable transmission power of the terminal device, first the transmission power of one or more LCHs in the second set can be decreased, or the transmission of one or more LCHs in the second set can be dropped. The transmission power of one or more LCHs in the first set will be decreased only when the total transmission power still exceeds the maximum allowable transmission power after the transmissions of all the LCHs in the second set have been dropped.

Here, the method 600 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

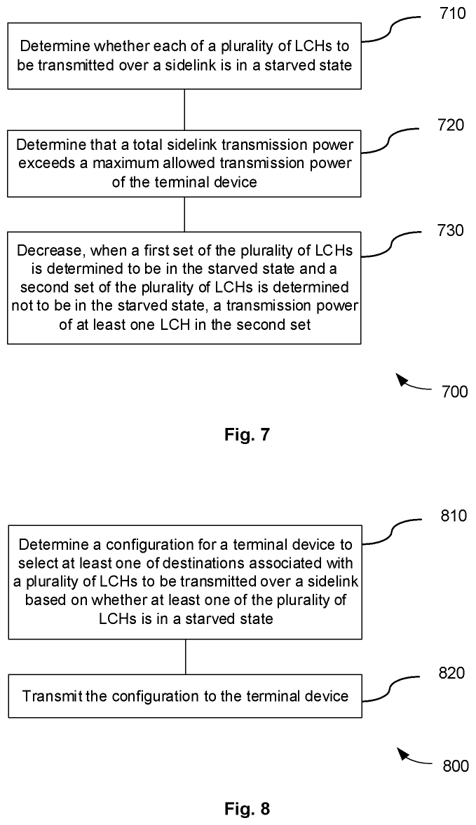

FIG. 7 is a flowchart illustrating a method 700 according to an embodiment of the present disclosure. The method 700 can be performed in a terminal device, e.g., a UE.

At block 710, it is determined whether each of a plurality of LCHs to be transmitted over a sidelink is in a starved state.

In an example, in the block 710, each LCH can be determined to be in the starved state when a scheduled data rate of the LCH is lower than or equal to a predefined data rate for the LCH. The scheduled data rate may be a current scheduled data rate, an average scheduled data rate over a last time period, an average of a number of last updated scheduled data rates, or each of P out of Q last updated scheduled data rates, where P and Q are configurable integers. For further details and illustrative examples, reference can be made to the method 100 as described above in connection with FIG. 1 and description thereof will be omitted here.

At block 720, it is determined that a total sidelink transmission power exceeds a maximum allowed transmission power of the terminal device.

At block 730, when a first set of the plurality of LCHs is determined to be in the starved state and a second set of the plurality of LCHs is determined not to be in the starved state, a transmission power of at least one LCH in the second set is decreased.

In an example, in the block 730, the operation of decreasing the transmission power of the at least one LCH may include dropping transmission of the at least one LCH. When the total sidelink transmission power exceeds the maximum allowed transmission power after transmissions of all the LCHs in the second set have been dropped, a transmission power of at least one LCH in the first set can be decreased.

Here, the method 700 can be performed in response to receiving from a network device (e.g., a gNB) a configuration for the terminal device to do so. In addition, the LCH priorities of the respective LCHs, the predefined data rates for the respective LCHs, and/or a rule regarding how to determine whether an LCH is in the starved state can be configured by the network device.

The above methods 100-700 can be combined with each other to avoid or at least mitigate starvation of LCHs in sidelink related procedures such as destination selection, channel sensing, uplink-sidelink prioritization, and/or sidelink-sidelink prioritization.

FIG. 8 is a flowchart illustrating a method 800 according to an embodiment of the present disclosure. The method 800 can be performed in a network node, e.g., a gNB.

At block 810, a configuration is determined, for a terminal device to select at least one of destinations associated with a plurality of LCHs to be transmitted over a sidelink based on whether at least one of the plurality of LCHs is in a starved state.

At block 820, the configuration is transmitted to the terminal device, such that the terminal device can operate in accordance with the configuration, e.g., to perform the method 100 as described above in connection with FIG. 1.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration can indicate that the terminal device is to select, when at least one of the plurality of LCHs is in the starved state, from at least one destination associated with the at least one LCH, a destination having a highest destination priority. Here a destination priority of each of the at least one destination is a highest LCH priority among LCH priorities of the respective LCHs associated with that destination that are in the starved state.

In an example, the configuration can indicate that the terminal device is to select, when none of the plurality of LCHs is in the starved state, from destinations associated with the plurality of LCHs, a destination having a highest destination priority. Here a destination priority of each destination is a highest LCH priority among LCH priorities of the respective LCHs associated with that destination.

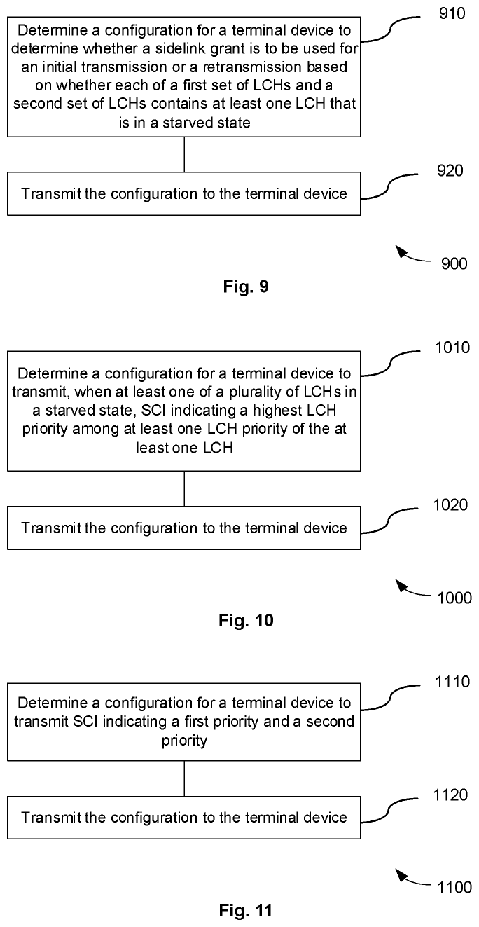

FIG. 9 is a flowchart illustrating a method 900 according to an embodiment of the present disclosure. The method 900 can be performed in a network node, e.g., a gNB.

At block 910, a configuration is determined, for a terminal device to determine whether a sidelink grant is to be used for an initial transmission or a retransmission based on whether each of a first set of LCHs and a second set of LCHs contains at least one LCH that is in a starved state.

At block 920, the configuration is transmitted to the terminal device, such that the terminal device can operate in accordance with the configuration, e.g., to perform the method 100 as described above in connection with FIG. 2.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration may indicate that the terminal device is to determine that the sidelink grant is to be used for the initial transmission when only the first set contains at least one LCH that is in the starved state, or for the retransmission when only the second set contains at least one LCH that is in the starved state.

In an example, the configuration may indicate that, when the first set contains a first subset of LCHs each in the starved state and the second set contains a second subset of LCHs each in the starved state, the terminal device is to determine that the sidelink grant is to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In an example, the configuration may indicates that, when the first set contains no LCH in the starved state and the second set contains no LCH in the starved state, the terminal device is to determine that the sidelink grant is to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

FIG. 10 is a flowchart illustrating a method 1000 according to an embodiment of the present disclosure. The method 1000 can be performed in a network node, e.g., a gNB.

At block 1010, a configuration is determined, for a terminal device to transmit, when at least one of a plurality of LCHs in a starved state, SCI indicating a highest LCH priority among at least one LCH priority of the at least one LCH.

At block 1020, the configuration is transmitted to the terminal device, such that the terminal device can operate in accordance with the configuration, e.g., to perform the method 300 as described above in connection with FIG. 3.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH.

The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration may indicate that the SCI is to further indicate presence of the at least one LCH in the starved state.

In an example, the configuration may indicate that the terminal device is to transmit, when none of the plurality of LCHs is in the starved state, SCI indicating a highest LCH priority among LCH priorities of the first and second sets of LCHs and absence of any LCH in the starved state.

FIG. 11 is a flowchart illustrating a method 1100 according to an embodiment of the present disclosure. The method 1100 can be performed in a network node, e.g., a gNB.

At block 1110, a configuration is determined, for a terminal device to transmit SCI indicating: a first priority which, when at least one of a plurality of LCHs to be transmitted over a sidelink is in a starved state, is a highest LCH priority among at least one LCH priority of the at least one LCH in the starved state; and a second priority which, when at least one of the plurality of LCHs is not in the starved state, is a highest LCH priority among at least one LCH priority of the at least one LCH not in the starved state.

At block 1120, the configuration is transmitted to the terminal device, such that the terminal device can operate in accordance with the configuration, e.g., to perform the method 400 as described above in connection with FIG. 4.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration may indicate that the terminal device is to: when none of the plurality of LCHs is in the starved state, set the first priority to a first priority value indicating that none of the plurality of LCHs is in the starved state; and when all of the plurality of LCHs are in the starved state, set the second priority to a second priority value indicating that all of the plurality of LCHs are in the starved state.

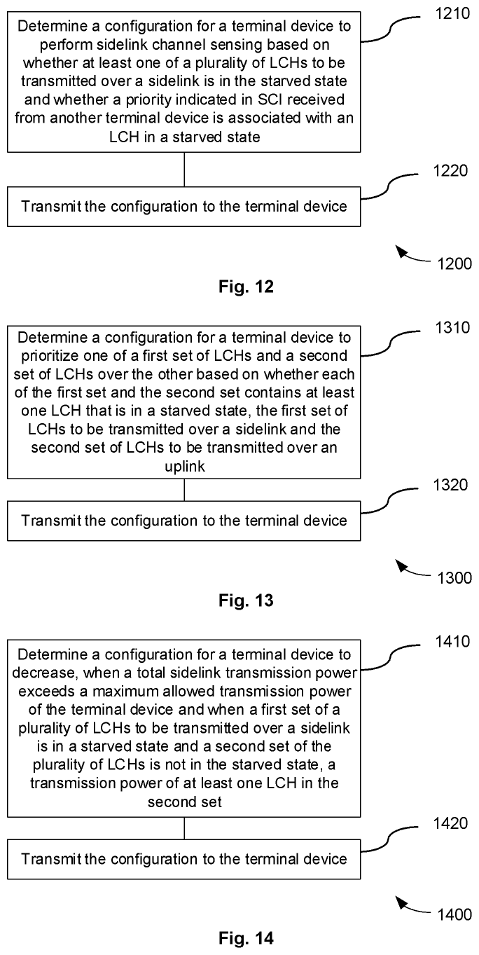

FIG. 12 is a flowchart illustrating a method 1200 according to an embodiment of the present disclosure. The method 1200 can be performed in a network node, e.g., a gNB.

At block 1210, a configuration is determined, for a terminal device to perform sidelink channel sensing based on whether at least one of a plurality of LCHs to be transmitted over a sidelink is in the starved state and whether a priority indicated in SCI received from another terminal device is associated with an LCH in a starved state.

At block 1220, the configuration is transmitted to the terminal device, such that the terminal device can operate in accordance with the configuration, e.g., to perform the method 500 as described above in connection with FIG. 5.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration may indicate that, when at least one of the plurality of LCHs is in the starved state and the indicated priority is associated with an LCH in the starved state, the terminal device is to perform the sidelink channel sensing based on a highest LCH priority among at least one LCH priority of the at least one LCH determined to be in the starved state and the indicated priority.

In an example, the configuration may indicate that, when none of the plurality of LCHs is in the starved state and the indicated priority is associated with an LCH in the starved state, the terminal device is to perform the sidelink channel sensing based on a priority lower than a predefined priority and the indicated priority.

In an example, the configuration may indicate that, when the indicated priority is not associated with an LCH in the starved state and the SCI indicates no priority associated with an LCH in the starved state and when at least one of the plurality of LCHs is in the starved state, the terminal device is to perform the sidelink channel sensing based on a highest LCH priority among at least one LCH priority of the at least one LCH determined to be in the starved state and a priority lower than a predefined priority.

FIG. 13 is a flowchart illustrating a method 1300 according to an embodiment of the present disclosure. The method 1300 can be performed in a network node, e.g., a gNB.

At block 1310, a configuration is determined, for a terminal device to prioritize one of a first set of LCHs and a second set of LCHs over the other based on whether each of the first set and the second set contains at least one LCH that is in a starved state, the first set of LCHs to be transmitted over a sidelink and the second set of LCHs to be transmitted over an uplink.

At block 1320, the configuration is transmitted to the terminal device, such that the terminal device can operate in accordance with the configuration, e.g., to perform the method 600 as described above in connection with FIG. 6.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the configuration may indicate that the terminal device is to prioritize, when a first subset of the first set of LCHs and a second subset of the second set of LCHs are in the starved state, one of the first set and the second set over the other based on a highest LCH priority among LCH priorities of the respective LCHs in the first subset and a highest LCH priority among LCH priorities of the respective LCHs in the second subset.

In an example, the configuration may indicate that the terminal device is to prioritize, when none of the first set of LCHs and the second set of LCHs is in the starved state, one of the first set and the second set over the other based on a highest LCH priority among LCH priorities of the respective LCHs in the first set and a highest LCH priority among LCH priorities of the respective LCHs in the second set.

In an example, the configuration may indicate that the terminal device is to: prioritize the first set over the second set, when at least one of the first set of LCHs is in the starved state while none of the second set of LCHs is in the starved state, or prioritize the second set over the first set, when at least one of the second set of LCHs is in the starved state while none of the first set of LCHs is in the starved state.

FIG. 14 is a flowchart illustrating a method 1400 according to an embodiment of the present disclosure. The method 1400 can be performed in a network node, e.g., a gNB.

At block 1410, a configuration is determined, for a terminal device to decrease, when a total sidelink transmission power exceeds a maximum allowed transmission power of the terminal device and when a first set of a plurality of LCHs to be transmitted over a sidelink is in a starved state and a second set of the plurality of LCHs is not in the starved state, a transmission power of at least one LCH in the second set.

At block 1420, the configuration is transmitted to the terminal device, such that the terminal device can operate in accordance with the configuration, e.g., to perform the method 700 as described above in connection with FIG. 7.

In an example, an indication of one or more of the following can be the transmitted to the terminal device: an LCH priority of at least one of the plurality of LCHs, a predefined data rate for at least one of the plurality of LCHs, or a rule for determining whether an LCH is in the starved state. For example, the rule may indicate that an LCH is determined to be in the starved state when a scheduled data rate of the LCH is lower than or equal to a predefined data rate for the LCH. The rule may further indicate that the scheduled data rate is one of: a current scheduled data rate, an average scheduled data rate over a last time period, an average of a number of last updated scheduled data rates, or each of P out of Q last updated scheduled data rates, where P and Q are integers. For further details and illustrative examples regarding the determination as to whether an LCH is in the starved state, reference can be made to the method 100 as described above in connection with FIG. 1 and description thereof will be omitted here.

In an example, the decreasing of the transmission power of the at least one LCH may include dropping transmission of the at least one LCH. The configuration may indicate that the terminal device is to decrease, when the total sidelink transmission power exceeds the maximum allowed transmission power after transmissions of all the LCHs in the second set have been dropped, a transmission power of at least one LCH in the first set.

The above methods 800-1400 can be combined with each other to avoid or at least mitigate starvation of LCHs in sidelink related procedures such as destination selection, channel sensing, uplink-sidelink prioritization, and/or sidelink-sidelink prioritization.

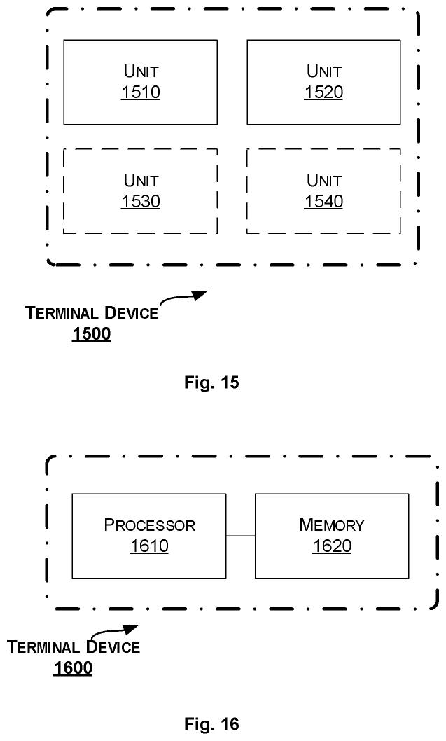

Correspondingly to the methods 100-700 as described above, a terminal device is provided. FIG. 15 is a block diagram of a terminal device 1500 according to an embodiment of the present disclosure.

The terminal device 1500 can be configured to perform the method 100 as described above in connection with FIG. 1. As shown in FIG. 15, the terminal device 1500 includes a unit 1510 (e.g., a determining unit) configured to determine whether each of a plurality of LCHs to be transmitted over a sidelink is in a starved state. In other words, the unit 1510 is configured to determine, for each of a plurality of LCHs to be transmitted over a sidelink, whether the LCH is in a starved state. The terminal device 1500 further includes a unit 1520 (e.g., a selecting unit) configured to select at least one of destinations associated with the plurality of LCHs based on whether at least one of the plurality of LCHs is determined to be in the starved state.

In an example, the unit 1510 can be configured to determine the LCH with LCH index j to be in the starved state when a variable Bj is greater than zero. Bj is maintained for the LCH with LCH index j and initially set to zero; Bj is incremented by product prioritisedBitRate(PBR)×T before every instance of a Logical Channel Prioritization, LCP, procedure, where prioritisedBitRate(PBR) is a prioritized bit rate and T is time elapsed since Bj was last incremented, and if Bj is greater than a bucket size, Bj is set to the bucket size.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the unit 1520 can be configured to select, when at least one of the plurality of LCHs is determined to be in the starved state, from at least one destination associated with the at least one LCH, a destination having a highest destination priority, wherein a destination priority of each of the at least one destination is a highest LCH priority among LCH priorities of the respective LCHs associated with that destination that are determined to be in the starved state.

In an example, the unit 1520 can be configured to select, when none of the plurality of LCHs is determined to be in the starved state, from destinations associated with the plurality of LCHs, a destination having a highest destination priority, wherein a destination priority of each destination is a highest LCH priority among LCH priorities of the respective LCHs associated with that destination.

Alternatively, the terminal device 1500 can be configured to perform the method 200 as described above in connection with FIG. 2. As shown in FIG. 15, the terminal device 1500 includes a unit 1510 (e.g., a first determining unit) configured to determine whether each of a plurality of LCHs is in a starved state, the plurality of LCHs including a first set of LCHs for initial transmission over a sidelink and a second set of LCHs for retransmission over the sikelink. The terminal device 1500 includes further a unit 1520 (e.g., a second determining unit) configured to determine whether a sidelink grant is to be used for the initial transmission or the retransmission based on whether each of the first set and the second set contains at least one LCH that is in the starved state.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the unit 1520 can be configured to determine that the sidelink grant is to be used for the initial transmission when only the first set contains at least one LCH that is in the starved state, or for the retransmission when only the second set contains at least one LCH that is in the starved state.

In an example, the unit 1520 can be configured to, when the first set contains a first subset of LCHs each in the starved state and the second set contains a second subset of LCHs each in the starved state: determine that the sidelink grant is to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In an example, the unit 1520 can be configured to, when the first set contains no LCH in the starved state and the second set contains no LCH in the starved state: determine that the sidelink grant is to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

Alternatively, the terminal device 1500 can be configured to perform the method 300 as described above in connection with FIG. 3. As shown in FIG. 15, the terminal device 1500 includes a unit 1510 (e.g., a determining unit) configured to determine whether each of a plurality of LCHs to be transmitted over a sidelink is in a starved state. The terminal device 1500 further includes a unit 1520 (e.g., a transmitting unit) configured to transmit, when at least one of the plurality of LCHs is determined to be in the starved state, SCI indicating a highest LCH priority among at least one LCH priority of the at least one LCH.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the SCI can further indicate presence of the at least one LCH in the starved state.

In an example, the unit 1520 can be further configured to transmit, when none of the plurality of LCHs is determined to be in the starved state, SCI indicating a highest LCH priority among LCH priorities of the plurality of LCHs and absence of any LCH in the starved state.

Alternatively, the terminal device 1500 can be configured to perform the method 400 as described above in connection with FIG. 4. As shown in FIG. 15, the terminal device 1500 includes a unit 1510 (e.g., a determining unit) configured to determine whether each of a plurality of LCHs to be transmitted over a sidelink is in a starved state. The terminal device 1500 further includes a unit 1520 (e.g., a transmitting unit) configured to transmit SCI indicating: a first priority which, when at least one of the plurality of LCHs is determined to be in the starved state, is a highest LCH priority among at least one LCH priority of the at least one LCH determined to be in the starved state, and a second priority which, when at least one of the plurality of LCHs is determined not to be in the starved state, is a highest LCH priority among at least one LCH priority of the at least one LCH determined not to be in the starved state.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, when none of the plurality of LCHs is determined to be in the starved state, the first priority is set to a first priority value indicating that none of the plurality of LCHs is determined to be in the starved state, and when all of the plurality of LCHs are determined to be in the starved state, the second priority is set to a second priority value indicating that all of the plurality of LCHs are determined to be in the starved state.

Alternatively, the terminal device 1500 can be configured to perform the method 500 as described above in connection with FIG. 5. As shown in FIG. 15, the terminal device 1500 includes a unit 1510 (e.g., a first determining unit) configured to determine whether each of a plurality of LCHs to be transmitted over a sidelink is in a starved state. The terminal device 1500 further includes a unit 1520 (e.g., a receiving unit) configured to receive, from another terminal device, SCI indicating at least a priority. The terminal device 1500 further includes a unit 1530 (e.g., a second determining unit) configured to determine whether the indicated priority is associated with an LCH in the starved state. The terminal device 1500 further includes a unit 1540 (e.g., a channel sensing unit) configured to perform, when at least one of the plurality of LCHs is determined to be in the starved state and the indicated priority is associated with an LCH in the starved state, sidelink channel sensing based on a highest LCH priority among at least one LCH priority of the at least one LCH determined to be in the starved state and the indicated priority.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the unit 1540 can be configured to: perform, when none of the plurality of LCHs is determined to be in the starved state and the indicated priority is associated with an LCH in the starved state, sidelink channel sensing based on a priority lower than a predefined priority and the indicated priority.

In an example, the unit 1530 can be further configured to, when it is determined that the indicated priority is not associated with an LCH in the starved state: determine that the SCI indicates no priority associated with an LCH in the starved state. The unit 1540 can be configured to: perform, when at least one of the plurality of LCHs is determined to be in the starved state, sidelink channel sensing based on a highest LCH priority among at least one LCH priority of the at least one LCH determined to be in the starved state and a priority lower than a predefined priority.

Alternatively, the terminal device 1500 can be configured to perform the method 600 as described above in connection with FIG. 6. As shown in FIG. 15, the terminal device 1500 includes a unit 1510 (e.g., a determining unit) configured to determine whether each LCH in a first set of LCHs to be transmitted over a sidelink and a second set of LCHs to be transmitted over an uplink is in a starved state. The terminal device 1500 further includes a unit 1520 (e.g., a prioritizing unit) configured to prioritize one of the first set and the second set over the other based on whether each of the first set and the second set contains at least one LCH that is in the starved state.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the unit 1520 can be configured to prioritize, when a first subset of the first set of LCHs and a second subset of the second set of LCHs are determined to be in the starved state, one of the first set and the second set over the other based on a highest LCH priority among LCH priorities of the respective LCHs in the first subset and a highest LCH priority among LCH priorities of the respective LCHs in the second subset.

In an example, the unit 1520 can be configured to prioritize, when none of the first set of LCHs and the second set of LCHs is determined to be in the starved state, one of the first set and the second set over the other based on a highest LCH priority among LCH priorities of the respective LCHs in the first set and a highest LCH priority among LCH priorities of the respective LCHs in the second set.

In an example, the unit 1520 can be configured to prioritize the first set over the second set, when at least one of the first set of LCHs is determined to be in the starved state while none of the second set of LCHs is determined to be in the starved state, or prioritize the second set over the first set, when at least one of the second set of LCHs is determined to be in the starved state while none of the first set of LCHs is determined to be in the starved state.

Alternatively, the terminal device 1500 can be configured to perform the method 700 as described above in connection with FIG. 7. As shown in FIG. 15, the terminal device 1500 includes a unit 1510 (e.g., a first determining unit) configured to determine whether each of a plurality of LCHs to be transmitted over a sidelink is in a starved state. The terminal device 1500 further includes a unit 1520 (e.g., a second determining unit) configured to determine that a total sidelink transmission power exceeds a maximum allowed transmission power of the terminal device. The terminal device 1500 further includes a unit 1530 (e.g., a decreasing unit) configured to decrease, when a first set of the plurality of LCHs is determined to be in the starved state and a second set of the plurality of LCHs is determined not to be in the starved state, a transmission power of at least one LCH in the second set.

In an example, the unit 1510 can be configured to determine the LCH to be in the starved state when a scheduled data rate of the LCH is lower than or equal to a predefined data rate for the LCH.

In an example, the scheduled data rate may include: a current scheduled data rate, an average scheduled data rate over a last time period, an average of a number of last updated scheduled data rates, or each of P out of Q last updated scheduled data rates, where P and Q are configurable integers.

In an example, the unit 1530 can be configured to drop transmission of the at least one LCH, and further configured to decrease, when the total sidelink transmission power exceeds the maximum allowed transmission power after transmissions of all the LCHs in the second set have been dropped, a transmission power of at least one LCH in the first set.

The above units 1510-1520 (and optionally the unit 1530 and/or the unit 1540) can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in any of FIGS. 1-7.

FIG. 16 is a block diagram of a terminal device 1600 according to another embodiment of the present disclosure.

The terminal device 1600 includes a processor 1610 and a memory 1620. The terminal device 1600 can further include a transceiver for communication over a sidelink and/or a Uu interface.

The memory 1620 can contain instructions executable by the processor 1610 whereby the terminal device 1600 is operative to perform the actions, e.g., of the procedure described earlier in conjunction with FIG. 1. Particularly, the memory 1620 can contain instructions executable by the processor 1610 whereby the terminal device 1600 is operative to: determine whether each of a plurality of LCHs to be transmitted over a sidelink is in a starved state; and select at least one of destinations associated with the plurality of LCHs based on whether at least one of the plurality of LCHs is determined to be in the starved state. In other words, the memory 1620 can contain instructions executable by the processor 1610 whereby the terminal device 1600 is operative to: determine, for each of a plurality of LCHs to be transmitted over a sidelink, whether the LCH is in a starved state; and select at least one of destinations associated with the plurality of LCHs based on whether at least one of the plurality of LCHs is determined to be in the starved state.

In an example, the operation of determining can include: determining the LCH with LCH index j to be in the starved state when a variable Bj is greater than zero. Bj is maintained for the LCH with LCH index j and initially set to zero; Bj is incremented by product prioritisedBitRate(PBR)×T before every instance of a Logical Channel Prioritization, LCP, procedure, where prioritisedBitRate(PBR) is a prioritized bit rate and T is time elapsed since Bj was last incremented, and if Bj is greater than a bucket size, Bj is set to the bucket size.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the operation of selecting can include: selecting, when at least one of the plurality of LCHs is determined to be in the starved state, from at least one destination associated with the at least one LCH, a destination having a highest destination priority, wherein a destination priority of each of the at least one destination is a highest LCH priority among LCH priorities of the respective LCHs associated with that destination that are determined to be in the starved state.

In an example, the operation of selecting can include: selecting, when none of the plurality of LCHs is determined to be in the starved state, from destinations associated with the plurality of LCHs, a destination having a highest destination priority, wherein a destination priority of each destination is a highest LCH priority among LCH priorities of the respective LCHs associated with that destination.

Alternatively, the memory 1620 can contain instructions executable by the processor 1610 whereby the terminal device 1600 is operative to perform the actions, e.g., of the procedure described earlier in conjunction with FIG. 2. Particularly, the memory 1620 can contain instructions executable by the processor 1610 whereby the terminal device 1600 is operative to: determine whether each of a plurality of LCHs is in a starved state, the plurality of LCHs including a first set of LCHs for initial transmission over a sidelink and a second set of LCHs for retransmission over the sikelink; and determine whether a sidelink grant is to be used for the initial transmission or the retransmission based on whether each of the first set and the second set contains at least one LCH that is in the starved state.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the operation of determining whether the sidelink grant is to be used for the initial transmission or the retransmission can include: determining that the sidelink grant is to be used for the initial transmission when only the first set contains at least one LCH that is in the starved state, or for the retransmission when only the second set contains at least one LCH that is in the starved state.

In an example, the operation of determining whether the sidelink grant is to be used for the initial transmission or the retransmission can include, when the first set contains a first subset of LCHs each in the starved state and the second set contains a second subset of LCHs each in the starved state: determining that the sidelink grant is to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In an example, the operation of determining whether the sidelink grant is to be used for the initial transmission or the retransmission can include, when the first set contains no LCH in the starved state and the second set contains no LCH in the starved state: determining that the sidelink grant is to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

Alternatively, the memory 1620 can contain instructions executable by the processor 1610 whereby the terminal device 1600 is operative to perform the actions, e.g., of the procedure described earlier in conjunction with FIG. 3. Particularly, the memory 1620 can contain instructions executable by the processor 1610 whereby the terminal device 1600 is operative to: determine whether each of a plurality of LCHs to be transmitted over a sidelink is in a starved state; and transmit, when at least one of the plurality of LCHs is determined to be in the starved state, SCI indicating a highest LCH priority among at least one LCH priority of the at least one LCH.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the SCI can further indicate presence of the at least one LCH in the starved state.

In an example, the memory 1620 can further contain instructions executable by the processor 1610 whereby the terminal device 1600 is operative to: transmit, when none of the plurality of LCHs is determined to be in the starved state, SCI indicating a highest LCH priority among LCH priorities of the plurality of LCHs and absence of any LCH in the starved state.

Alternatively, the memory 1620 can contain instructions executable by the processor 1610 whereby the terminal device 1600 is operative to perform the actions, e.g., of the procedure described earlier in conjunction with FIG. 4. Particularly, the memory 1620 can contain instructions executable by the processor 1610 whereby the terminal device 1600 is operative to: determine whether each of a plurality of LCHs to be transmitted over a sidelink is in a starved state; and transmit SCI indicating: a first priority which, when at least one of the plurality of LCHs is determined to be in the starved state, is a highest LCH priority among at least one LCH priority of the at least one LCH determined to be in the starved state; and a second priority which, when at least one of the plurality of LCHs is determined not to be in the starved state, is a highest LCH priority among at least one LCH priority of the at least one LCH determined not to be in the starved state.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, when none of the plurality of LCHs is determined to be in the starved state, the first priority is set to a first priority value indicating that none of the plurality of LCHs is determined to be in the starved state, and when all of the plurality of LCHs are determined to be in the starved state, the second priority is set to a second priority value indicating that all of the plurality of LCHs are determined to be in the starved state.

Alternatively, the memory 1620 can contain instructions executable by the processor 1610 whereby the terminal device 1600 is operative to perform the actions, e.g., of the procedure described earlier in conjunction with FIG. 5. Particularly, the memory 1620 can contain instructions executable by the processor 1610 whereby the terminal device 1600 is operative to: determine whether each of a plurality of LCHs to be transmitted over a sidelink is in a starved state; receive, from another terminal device, SCI indicating at least a priority; determine whether the indicated priority is associated with an LCH in the starved state; and perform, when at least one of the plurality of LCHs is determined to be in the starved state and the indicated priority is associated with an LCH in the starved state, sidelink channel sensing based on a highest LCH priority among at least one LCH priority of the at least one LCH determined to be in the starved state and the indicated priority.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the memory 1620 can further contain instructions executable by the processor 1610 whereby the terminal device 1600 is operative to: perform, when none of the plurality of LCHs is determined to be in the starved state and the indicated priority is associated with an LCH in the starved state, sidelink channel sensing based on a priority lower than a predefined priority and the indicated priority.

In an example, the memory 1620 can further contain instructions executable by the processor 1610 whereby the terminal device 1600 is operative to, when it is determined that the indicated priority is not associated with an LCH in the starved state: determine that the SCI indicates no priority associated with an LCH in the starved state; and perform, when at least one of the plurality of LCHs is determined to be in the starved state, sidelink channel sensing based on a highest LCH priority among at least one LCH priority of the at least one LCH determined to be in the starved state and a priority lower than a predefined priority.

Alternatively, the memory 1620 can contain instructions executable by the processor 1610 whereby the terminal device 1600 is operative to perform the actions, e.g., of the procedure described earlier in conjunction with FIG. 6. Particularly, the memory 1620 can contain instructions executable by the processor 1610 whereby the terminal device 1600 is operative to: determine whether each LCH in a first set of LCHs to be transmitted over a sidelink and a second set of LCHs to be transmitted over an uplink is in a starved state; and prioritize one of the first set and the second set over the other based on whether each of the first set and the second set contains at least one LCH that is in the starved state.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the operation of prioritizing can include: prioritizing, when a first subset of the first set of LCHs and a second subset of the second set of LCHs are determined to be in the starved state, one of the first set and the second set over the other based on a highest LCH priority among LCH priorities of the respective LCHs in the first subset and a highest LCH priority among LCH priorities of the respective LCHs in the second subset.

In an example, the operation of prioritizing can include: prioritizing, when none of the first set of LCHs and the second set of LCHs is determined to be in the starved state, one of the first set and the second set over the other based on a highest LCH priority among LCH priorities of the respective LCHs in the first set and a highest LCH priority among LCH priorities of the respective LCHs in the second set.

In an example, the operation of prioritizing can include: prioritizing the first set over the second set, when at least one of the first set of LCHs is determined to be in the starved state while none of the second set of LCHs is determined to be in the starved state, or prioritizing the second set over the first set, when at least one of the second set of LCHs is determined to be in the starved state while none of the first set of LCHs is determined to be in the starved state.

Alternatively, the memory 1620 can contain instructions executable by the processor 1610 whereby the terminal device 1600 is operative to perform the actions, e.g., of the procedure described earlier in conjunction with FIG. 7. Particularly, the memory 1620 can contain instructions executable by the processor 1610 whereby the terminal device 1600 is operative to: determine whether each of a plurality of LCHs to be transmitted over a sidelink is in a starved state; and determine that a total sidelink transmission power exceeds a maximum allowed transmission power of the terminal device; and decrease, when a first set of the plurality of LCHs is determined to be in the starved state and a second set of the plurality of LCHs is determined not to be in the starved state, a transmission power of at least one LCH in the second set.

In an example, the operation of determining whether each LCH is in the starved state can include: determining the LCH to be in the starved state when a scheduled data rate of the LCH is lower than or equal to a predefined data rate for the LCH.

In an example, the scheduled data rate can include: a current scheduled data rate, an average scheduled data rate over a last time period, an average of a number of last updated scheduled data rates, or each of P out of Q last updated scheduled data rates, where P and Q are configurable integers.

In an example, the operation of decreasing the transmission power of the at least one LCH can include dropping transmission of the at least one LCH. The memory 1620 can further contain instructions executable by the processor 1610 whereby the terminal device 1600 is operative to: decrease, when the total sidelink transmission power exceeds the maximum allowed transmission power after transmissions of all the LCHs in the second set have been dropped, a transmission power of at least one LCH in the first set.

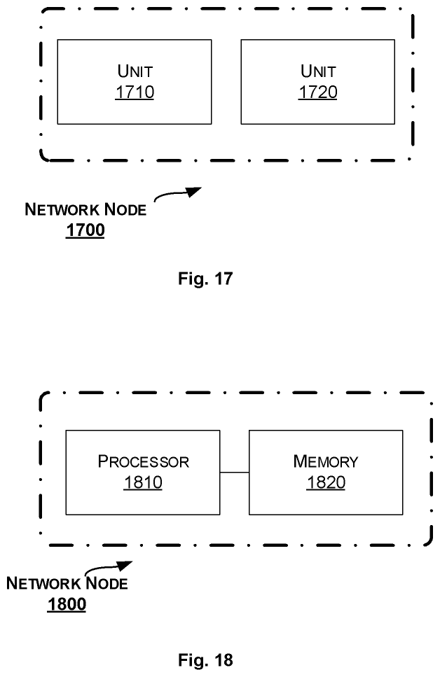

Correspondingly to the methods 800-1400 as described above, a network node is provided. FIG. 17 is a block diagram of a network node 1700 according to an embodiment of the present disclosure.

The network node 1700 can be configured to perform the method 100 as described above in connection with FIG. 8. As shown in FIG. 17, the network node 1700 includes a unit 1710 (e.g., a determining unit) configured to determine a configuration for a terminal device to select at least one of destinations associated with a plurality of LCHs to be transmitted over a sidelink based on whether at least one of the plurality of LCHs is in a starved state. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to select, when at least one of the plurality of LCHs is in the starved state, from at least one destination associated with the at least one LCH, a destination having a highest destination priority, wherein a destination priority of each of the at least one destination is a highest LCH priority among LCH priorities of the respective LCHs associated with that destination that are in the starved state.

In an example, the configuration can indicate that the terminal device is to select, when none of the plurality of LCHs is in the starved state, from destinations associated with the plurality of LCHs, a destination having a highest destination priority, wherein a destination priority of each destination is a highest LCH priority among LCH priorities of the respective LCHs associated with that destination.

Alternatively, the network node 1700 can be configured to perform the method 100 as described above in connection with FIG. 9. As shown in FIG. 17, the network node 1700 includes a unit 1710 (e.g., a determining unit) configured to determine a configuration for a terminal device to determine whether a sidelink grant is to be used for an initial transmission or a retransmission based on whether each of a first set of LCHs and a second set of LCHs contains at least one LCH that is in a starved state. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to determine that the sidelink grant is to be used for the initial transmission when only the first set contains at least one LCH that is in the starved state, or for the retransmission when only the second set contains at least one LCH that is in the starved state.

In an example, the configuration can indicate that, when the first set contains a first subset of LCHs each in the starved state and the second set contains a second subset of LCHs each in the starved state, the terminal device is to determine that the sidelink grant is to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In an example, the configuration can indicate that, when the first set contains no LCH in the starved state and the second set contains no LCH in the starved state, the terminal device is to determine that the sidelink grant is to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

Alternatively, the network node 1700 can be configured to perform the method 100 as described above in connection with FIG. 10. As shown in FIG. 17, the network node 1700 includes a unit 1710 (e.g., a determining unit) configured to determine a configuration for a terminal device to transmit, when at least one of a plurality of LCHs in a starved state, SCI indicating a highest LCH priority among at least one LCH priority of the at least one LCH. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the SCI is to further indicate presence of the at least one LCH in the starved state.

In an example, the configuration can indicate that the terminal device is to transmit, when none of the plurality of LCHs is in the starved state, SCI indicating a highest LCH priority among LCH priorities of the first and second sets of LCHs and absence of any LCH in the starved state.

Alternatively, the network node 1700 can be configured to perform the method 100 as described above in connection with FIG. 11. As shown in FIG. 17, the network node 1700 includes a unit 1710 (e.g., a determining unit) configured to determine a configuration for a terminal device to transmit SCI indicating: a first priority which, when at least one of a plurality of LCHs to be transmitted over a sidelink is in a starved state, is a highest LCH priority among at least one LCH priority of the at least one LCH in the starved state, and a second priority which, when at least one of the plurality of LCHs is not in the starved state, is a highest LCH priority among at least one LCH priority of the at least one LCH not in the starved state. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to: when none of the plurality of LCHs is in the starved state, set the first priority to a first priority value indicating that none of the plurality of LCHs is in the starved state; and when all of the plurality of LCHs are in the starved state, set the second priority to a second priority value indicating that all of the plurality of LCHs are in the starved state.

Alternatively, the network node 1700 can be configured to perform the method 100 as described above in connection with FIG. 12. As shown in FIG. 17, the network node 1700 includes a unit 1710 (e.g., a determining unit) configured to determine a configuration for a terminal device to perform sidelink channel sensing based on whether at least one of a plurality of LCHs to be transmitted over a sidelink is in the starved state and whether a priority indicated in SCI received from another terminal device is associated with an LCH in a starved state. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that, when at least one of the plurality of LCHs is in the starved state and the indicated priority is associated with an LCH in the starved state, the terminal device is to perform the sidelink channel sensing based on a highest LCH priority among at least one LCH priority of the at least one LCH determined to be in the starved state and the indicated priority.

In an example, the configuration can indicate that, when none of the plurality of LCHs is in the starved state and the indicated priority is associated with an LCH in the starved state, the terminal device is to perform the sidelink channel sensing based on a priority lower than a predefined priority and the indicated priority.

In an example, the configuration can indicate that, when the indicated priority is not associated with an LCH in the starved state and the SCI indicates no priority associated with an LCH in the starved state and when at least one of the plurality of LCHs is in the starved state, the terminal device is to perform the sidelink channel sensing based on a highest LCH priority among at least one LCH priority of the at least one LCH determined to be in the starved state and a priority lower than a predefined priority.

Alternatively, the network node 1700 can be configured to perform the method 100 as described above in connection with FIG. 13. As shown in FIG. 17, the network node 1700 includes a unit 1710 (e.g., a determining unit) configured to determine a configuration for a terminal device to prioritize one of a first set of LCHs and a second set of LCHs over the other based on whether each of the first set and the second set contains at least one LCH that is in a starved state, the first set of LCHs to be transmitted over a sidelink and the second set of LCHs to be transmitted over an uplink. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to prioritize, when a first subset of the first set of LCHs and a second subset of the second set of LCHs are in the starved state, one of the first set and the second set over the other based on a highest LCH priority among LCH priorities of the respective LCHs in the first subset and a highest LCH priority among LCH priorities of the respective LCHs in the second subset.

In an example, the configuration can indicate that the terminal device is to prioritize, when none of the first set of LCHs and the second set of LCHs is in the starved state, one of the first set and the second set over the other based on a highest LCH priority among LCH priorities of the respective LCHs in the first set and a highest LCH priority among LCH priorities of the respective LCHs in the second set.

In an example, the configuration can indicate that the terminal device is to: prioritize the first set over the second set, when at least one of the first set of LCHs is in the starved state while none of the second set of LCHs is in the starved state, or prioritize the second set over the first set, when at least one of the second set of LCHs is in the starved state while none of the first set of LCHs is in the starved state.

Alternatively, the network node 1700 can be configured to perform the method 100 as described above in connection with FIG. 14. As shown in FIG. 17, the network node 1700 includes a unit 1710 (e.g., a determining unit) configured to determine a configuration for a terminal device to decrease, when a total sidelink transmission power exceeds a maximum allowed transmission power of the terminal device and when a first set of a plurality of LCHs to be transmitted over a sidelink is in a starved state and a second set of the plurality of LCHs is not in the starved state, a transmission power of at least one LCH in the second set. The network node 1700 further includes a unit 1720 (e.g., a transmitting unit) configured to transmit the configuration to the terminal device.

In an example, the unit 1720 can be further configured to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the operation decreasing the transmission power of the at least one LCH can include dropping transmission of the at least one LCH. The configuration can indicate that the terminal device is to decrease, when the total sidelink transmission power exceeds the maximum allowed transmission power after transmissions of all the LCHs in the second set have been dropped, a transmission power of at least one LCH in the first set.

The above units 1710-1720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in any of FIGS. 8-14.

FIG. 18 is a block diagram of a network node 1800 according to another embodiment of the present disclosure.

The network node 1800 includes a processor 1810 and a memory 1820. The network node 1800 can further include a transceiver, e.g., for communication over a Uu interface.

The memory 1820 can contain instructions executable by the processor 1810 whereby the network node 1800 is operative to perform the actions, e.g., of the procedure described earlier in conjunction with FIG. 8. Particularly, the memory 1820 can contain instructions executable by the processor 1810 whereby the network node 1800 is operative to: determine a configuration for a terminal device to select at least one of destinations associated with a plurality of LCHs to be transmitted over a sidelink based on whether at least one of the plurality of LCHs is in a starved state; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to select, when at least one of the plurality of LCHs is in the starved state, from at least one destination associated with the at least one LCH, a destination having a highest destination priority, wherein a destination priority of each of the at least one destination is a highest LCH priority among LCH priorities of the respective LCHs associated with that destination that are in the starved state.

In an example, the configuration can indicate that the terminal device is to select, when none of the plurality of LCHs is in the starved state, from destinations associated with the plurality of LCHs, a destination having a highest destination priority, wherein a destination priority of each destination is a highest LCH priority among LCH priorities of the respective LCHs associated with that destination.

Alternatively, the memory 1820 can contain instructions executable by the processor 1810 whereby the network node 1800 is operative to perform the actions, e.g., of the procedure described earlier in conjunction with FIG. 9. Particularly, the memory 1820 can contain instructions executable by the processor 1810 whereby the network node 1800 is operative to: determine a configuration for a terminal device to determine whether a sidelink grant is to be used for an initial transmission or a retransmission based on whether each of a first set of LCHs and a second set of LCHs contains at least one LCH that is in a starved state; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to determine that the sidelink grant is to be used for the initial transmission when only the first set contains at least one LCH that is in the starved state, or for the retransmission when only the second set contains at least one LCH that is in the starved state.

In an example, the configuration can indicate that, when the first set contains a first subset of LCHs each in the starved state and the second set contains a second subset of LCHs each in the starved state, the terminal device is to determine that the sidelink grant is to be used for the initial transmission when a highest LCH priority among LCH priorities of the respective LCHs in the first subset is higher than a highest LCH priority among LCH priorities of the respective LCHs in the second subset, or for the retransmission when the highest LCH priority among LCH priorities of the respective LCHs in the second subset is higher than the highest LCH priority among LCH priorities of the respective LCHs in the first subset.

In an example, the configuration can indicate that, when the first set contains no LCH in the starved state and the second set contains no LCH in the starved state, the terminal device is to determine that the sidelink grant is to be used for the initial transmission when a highest LCH priority among LCH priorities of the respective LCHs in the first set is higher than a highest LCH priority among LCH priorities of the respective LCHs in the second set, or for the retransmission when the highest LCH priority among LCH priorities of the respective LCHs in the second set is higher than the highest LCH priority among LCH priorities of the respective LCHs in the first set.

Alternatively, the memory 1820 can contain instructions executable by the processor 1810 whereby the network node 1800 is operative to perform the actions, e.g., of the procedure described earlier in conjunction with FIG. 10. Particularly, the memory 1820 can contain instructions executable by the processor 1810 whereby the network node 1800 is operative to: determine a configuration for a terminal device to transmit, when at least one of a plurality of LCHs in a starved state, SCI indicating a highest LCH priority among at least one LCH priority of the at least one LCH; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the SCI is to further indicate presence of the at least one LCH in the starved state.

In an example, the configuration can indicate that the terminal device is to transmit, when none of the plurality of LCHs is in the starved state, SCI indicating a highest LCH priority among LCH priorities of the first and second sets of LCHs and absence of any LCH in the starved state.

Alternatively, the memory 1820 can contain instructions executable by the processor 1810 whereby the network node 1800 is operative to perform the actions, e.g., of the procedure described earlier in conjunction with FIG. 11. Particularly, the memory 1820 can contain instructions executable by the processor 1810 whereby the network node 1800 is operative to: determine a configuration for a terminal device to transmit SCI indicating a first priority which, when at least one of a plurality of LCHs to be transmitted over a sidelink is in a starved state, is a highest LCH priority among at least one LCH priority of the at least one LCH in the starved state, and a second priority which, when at least one of the plurality of LCHs is not in the starved state, is a highest LCH priority among at least one LCH priority of the at least one LCH not in the starved state; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to: when none of the plurality of LCHs is in the starved state, set the first priority to a first priority value indicating that none of the plurality of LCHs is in the starved state; and when all of the plurality of LCHs are in the starved state, set the second priority to a second priority value indicating that all of the plurality of LCHs are in the starved state.

Alternatively, the memory 1820 can contain instructions executable by the processor 1810 whereby the network node 1800 is operative to perform the actions, e.g., of the procedure described earlier in conjunction with FIG. 12. Particularly, the memory 1820 can contain instructions executable by the processor 1810 whereby the network node 1800 is operative to: determine a configuration for a terminal device to perform sidelink channel sensing based on whether at least one of a plurality of LCHs to be transmitted over a sidelink is in the starved state and whether a priority indicated in SCI received from another terminal device is associated with an LCH in a starved state; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that, when at least one of the plurality of LCHs is in the starved state and the indicated priority is associated with an LCH in the starved state, the terminal device is to perform the sidelink channel sensing based on a highest LCH priority among at least one LCH priority of the at least one LCH determined to be in the starved state and the indicated priority.

In an example, the configuration can indicate that, when none of the plurality of LCHs is in the starved state and the indicated priority is associated with an LCH in the starved state, the terminal device is to perform the sidelink channel sensing based on a priority lower than a predefined priority and the indicated priority.

In an example, the configuration can indicate that, when the indicated priority is not associated with an LCH in the starved state and the SCI indicates no priority associated with an LCH in the starved state and when at least one of the plurality of LCHs is in the starved state, the terminal device is to perform the sidelink channel sensing based on a highest LCH priority among at least one LCH priority of the at least one LCH determined to be in the starved state and a priority lower than a predefined priority.

Alternatively, the memory 1820 can contain instructions executable by the processor 1810 whereby the network node 1800 is operative to perform the actions, e.g., of the procedure described earlier in conjunction with FIG. 13. Particularly, the memory 1820 can contain instructions executable by the processor 1810 whereby the network node 1800 is operative to: determine a configuration for a terminal device to prioritize one of a first set of LCHs and a second set of LCHs over the other based on whether each of the first set and the second set contains at least one LCH that is in a starved state, the first set of LCHs to be transmitted over a sidelink and the second set of LCHs to be transmitted over an uplink; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the configuration can indicate that the terminal device is to prioritize, when a first subset of the first set of LCHs and a second subset of the second set of LCHs are in the starved state, one of the first set and the second set over the other based on a highest LCH priority among LCH priorities of the respective LCHs in the first subset and a highest LCH priority among LCH priorities of the respective LCHs in the second subset.

In an example, the configuration can indicate that the terminal device is to prioritize, when none of the first set of LCHs and the second set of LCHs is in the starved state, one of the first set and the second set over the other based on a highest LCH priority among LCH priorities of the respective LCHs in the first set and a highest LCH priority among LCH priorities of the respective LCHs in the second set.

In an example, the configuration can indicate that the terminal device is to: prioritize the first set over the second set, when at least one of the first set of LCHs is in the starved state while none of the second set of LCHs is in the starved state, or prioritize the second set over the first set, when at least one of the second set of LCHs is in the starved state while none of the first set of LCHs is in the starved state.

Alternatively, the memory 1820 can contain instructions executable by the processor 1810 whereby the network node 1800 is operative to perform the actions, e.g., of the procedure described earlier in conjunction with FIG. 14. Particularly, the memory 1820 can contain instructions executable by the processor 1810 whereby the network node 1800 is operative to: determine a configuration for a terminal device to decrease, when a total sidelink transmission power exceeds a maximum allowed transmission power of the terminal device and when a first set of a plurality of LCHs to be transmitted over a sidelink is in a starved state and a second set of the plurality of LCHs is not in the starved state, a transmission power of at least one LCH in the second set; and transmit the configuration to the terminal device.

In an example, the memory 1820 can further contain instructions executable by the processor 1810 whereby the network node 1800 is operative to transmit to the terminal device an indication of one or more of: an LCH priority of at least one of the plurality of LCHs, a predefined data rate for at least one of the plurality of LCHs, or a rule for determining whether an LCH is in the starved state.

In an example, the rule can indicate that an LCH is determined to be in the starved state when a scheduled data rate of the LCH is lower than or equal to a predefined data rate for the LCH.

In an example, the rule can further indicate that the scheduled data rate is one of: a current scheduled data rate, an average scheduled data rate over a last time period, an average of a number of last updated scheduled data rates, or each of P out of Q last updated scheduled data rates, where P and Q are integers.

In an example, the operation of decreasing the transmission power of the at least one LCH can include dropping transmission of the at least one LCH. The configuration can indicate that the terminal device is to decrease, when the total sidelink transmission power exceeds the maximum allowed transmission power after transmissions of all the LCHs in the second set have been dropped, a transmission power of at least one LCH in the first set.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1610 causes the terminal device 1600 to perform the actions, e.g., of the procedure described earlier in conjunction with any of FIGS. 1-7; or code/computer readable instructions, which when executed by the processor 1810 causes the network node 1800 to perform the actions, e.g., of the procedure described earlier in conjunction with any of FIGS. 8-14.

The computer program product may be configured as a computer program code structured in computer program modules. The computer program modules could essentially perform the actions of the flow illustrated in any of FIGS. 1-14.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

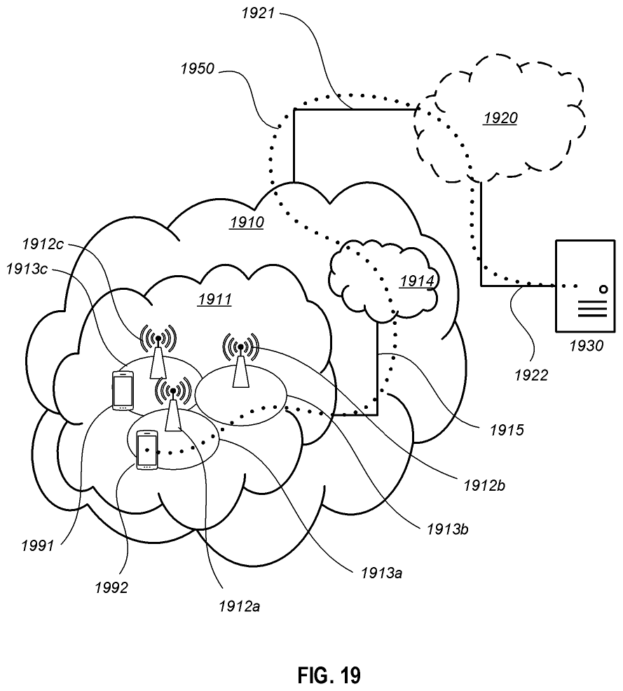

With reference to FIG. 19, in accordance with an embodiment, a communication system includes a telecommunication network 1910, such as a 3GPP-type cellular network, which comprises an access network 1911, such as a radio access network, and a core network 1914. The access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to the core network 1914 over a wired or wireless connection 1915. A first UE 1991 located in a coverage area 1913c is configured to wirelessly connect to, or be paged by, the corresponding base station 1912c. A second UE 1992 in a coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

The telecommunication network 1910 is itself connected to a host computer 1930, which may be embodied in the hardware and/or software of a standalone server, a cloud-implemented server, a distributed server or as processing resources in a server farm. The host computer 1930 may be under the ownership or control of a service provider, or may be operated by the service provider or on behalf of the service provider. Connections 1921 and 1922 between the telecommunication network 1910 and the host computer 1930 may extend directly from the core network 1914 to the host computer 1930 or may go via an optional intermediate network 1920. An intermediate network 1920 may be one of, or a combination of more than one of, a public, private or hosted network; the intermediate network 1920, if any, may be a backbone network or the Internet; in particular, the intermediate network 1920 may comprise two or more sub-networks (not shown).

The communication system of FIG. 19 as a whole enables connectivity between the connected UEs 1991, 1992 and the host computer 1930. The connectivity may be described as an over-the-top (OTT) connection 1950. The host computer 1930 and the connected UEs 1991, 1992 are configured to communicate data and/or signaling via the OTT connection 1950, using the access network 1911, the core network 1914, any intermediate network 1920 and possible further infrastructure (not shown) as intermediaries. The OTT connection 1950 may be transparent in the sense that the participating communication devices through which the OTT connection 1950 passes are unaware of routing of uplink and downlink communications. For example, the base station 1912 may not or need not be informed about the past routing of an incoming downlink communication with data originating from the host computer 1930 to be forwarded (e.g., handed over) to a connected UE 1991. Similarly, the base station 1912 need not be aware of the future routing of an outgoing uplink communication originating from the UE 1991 towards the host computer 1930.

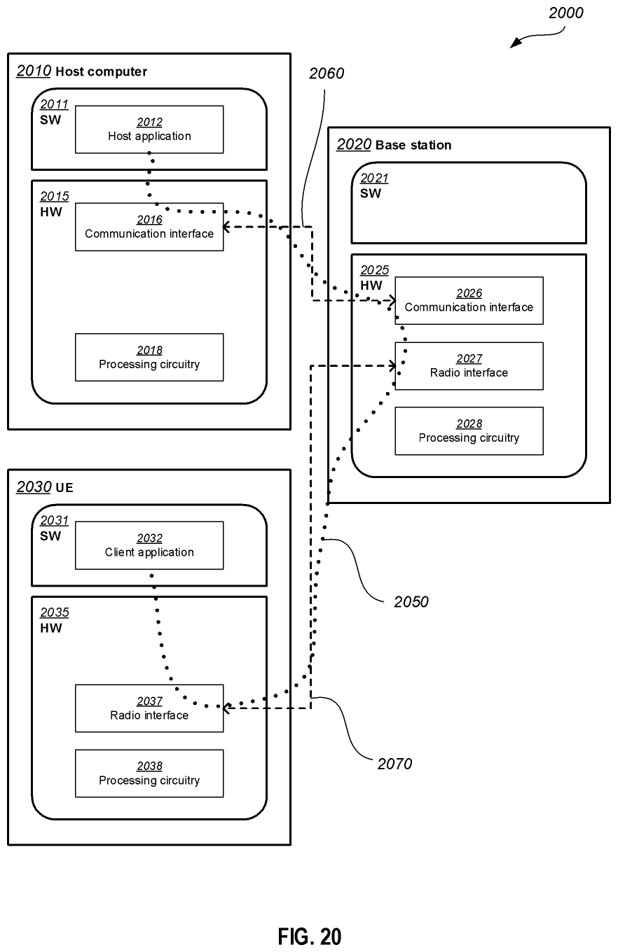

Example implementations, in accordance with an embodiment, of the UE, base station and host computer discussed in the preceding paragraphs will now be described with reference to FIG. 20. In a communication system 2000, a host computer 2010 comprises hardware 2015 including a communication interface 2016 configured to set up and maintain a wired or wireless connection with an interface of a different communication device of the communication system 2000. The host computer 2010 further comprises a processing circuitry 2018, which may have storage and/or processing capabilities. In particular, the processing circuitry 2018 may comprise one or more programmable processors, application-specific integrated circuits, field programmable gate arrays or combinations of these (not shown) adapted to execute instructions. The host computer 2010 further comprises software 2011, which is stored in or accessible by the host computer 2010 and executable by the processing circuitry 2018. The software 2011 includes a host application 2012. The host application 2012 may be operable to provide a service to a remote user, such as UE 2030 connecting via an OTT connection 2050 terminating at the UE 2030 and the host computer 2010. In providing the service to the remote user, the host application 2012 may provide user data which is transmitted using the OTT connection 2050.

The communication system 2000 further includes a base station 2020 provided in a telecommunication system and comprising hardware 2025 enabling it to communicate with the host computer 2010 and with the UE 2030. The hardware 2025 may include a communication interface 2026 for setting up and maintaining a wired or wireless connection with an interface of a different communication device of the communication system 2000, as well as a radio interface 2027 for setting up and maintaining at least a wireless connection 2070 with the UE 2030 located in a coverage area (not shown in FIG. 20) served by the base station 2020. The communication interface 2026 may be configured to facilitate a connection 2060 to the host computer 2010. The connection 2060 may be direct or it may pass through a core network (not shown in FIG. 20) of the telecommunication system and/or through one or more intermediate networks outside the telecommunication system. In the embodiment shown, the hardware 2025 of the base station 2020 further includes a processing circuitry 2028, which may comprise one or more programmable processors, application-specific integrated circuits, field programmable gate arrays or combinations of these (not shown) adapted to execute instructions. The base station 2020 further has software 2021 stored internally or accessible via an external connection.

The communication system 2000 further includes the UE 2030 already referred to. Its hardware 2035 may include a radio interface 2037 configured to set up and maintain a wireless connection 2070 with a base station serving a coverage area in which the UE 2030 is currently located. The hardware 2035 of the UE 2030 further includes a processing circuitry 2038, which may comprise one or more programmable processors, application-specific integrated circuits, field programmable gate arrays or combinations of these (not shown) adapted to execute instructions. The UE 2030 further comprises software 2031, which is stored in or accessible by the UE 2030 and executable by the processing circuitry 2038. The software 2031 includes a client application 2032. The client application 2032 may be operable to provide a service to a human or non-human user via the UE 2030, with the support of the host computer 2010. In the host computer 2010, an executing host application 2012 may communicate with the executing client application 2032 via the OTT connection 2050 terminating at the UE 2030 and the host computer 2010. In providing the service to the user, the client application 2032 may receive request data from the host application 2012 and provide user data in response to the request data. The OTT connection 2050 may transfer both the request data and the user data. The client application 2032 may interact with the user to generate the user data that it provides.

It is noted that the host computer 2010, the base station 2020 and the UE 2030 illustrated in FIG. 20 may be similar or identical to the host computer 1930, one of base stations 1912a, 1912b, 1912c and one of UEs 1991, 1992 of FIG. 19, respectively. This is to say, the inner workings of these entities may be as shown in FIG. 20 and independently, the surrounding network topology may be that of FIG. 19.

In FIG. 20, the OTT connection 2050 has been drawn abstractly to illustrate the communication between the host computer 2010 and the UE 2030 via the base station 2020, without explicit reference to any intermediary devices and the precise routing of messages via these devices. Network infrastructure may determine the routing, which it may be configured to hide from the UE 2030 or from the service provider operating the host computer 2010, or both. While the OTT connection 2050 is active, the network infrastructure may further take decisions by which it dynamically changes the routing (e.g., on the basis of load balancing consideration or reconfiguration of the network).

Wireless connection 2070 between the UE 2030 and the base station 2020 is in accordance with the teachings of the embodiments described throughout this disclosure. One or more of the various embodiments improve the performance of OTT services provided to the UE 2030 using the OTT connection 2050, in which the wireless connection 2070 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 2050 between the host computer 2010 and the UE 2030, in response to variations in the measurement results. The measurement procedure and/or the network functionality for reconfiguring the OTT connection 2050 may be implemented in software 2011 and hardware 2015 of the host computer 2010 or in software 2031 and hardware 2035 of the UE 2030, or both. In embodiments, sensors (not shown) may be deployed in or in association with communication devices through which the OTT connection 2050 passes; the sensors may participate in the measurement procedure by supplying values of the monitored quantities exemplified above, or supplying values of other physical quantities from which the software 2011, 2031 may compute or estimate the monitored quantities. The reconfiguring of the OTT connection 2050 may include message format, retransmission settings, preferred routing etc.; the reconfiguring need not affect the base station 2020, and it may be unknown or imperceptible to the base station 2020. Such procedures and functionalities may be known and practiced in the art. In certain embodiments, measurements may involve proprietary UE signaling facilitating the host computer 2010's measurements of throughput, propagation times, latency and the like. The measurements may be implemented in that the software 2011 and 2031 causes messages to be transmitted, in particular empty or ‘dummy’ messages, using the OTT connection 2050 while it monitors propagation times, errors etc.

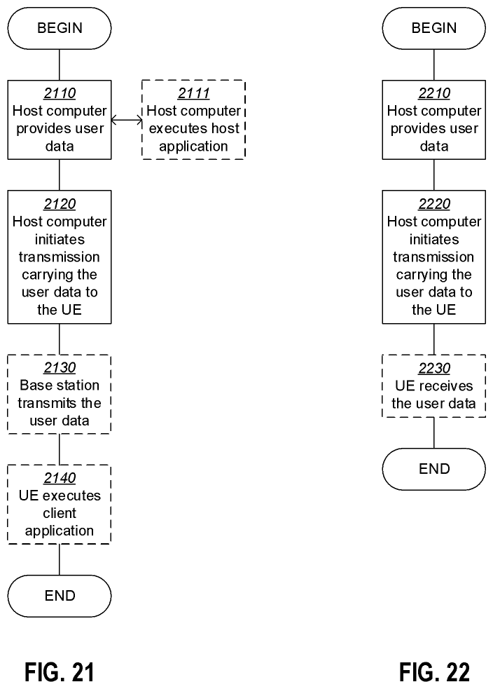

FIG. 21 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 21 will be included in this section. In step 2110, the host computer provides user data. In substep 2111 (which may be optional) of step 2110, the host computer provides the user data by executing a host application. In step 2120, the host computer initiates a transmission carrying the user data to the UE. In step 2130 (which may be optional), the base station transmits to the UE the user data which was carried in the transmission that the host computer initiated, in accordance with the teachings of the embodiments described throughout this disclosure. In step 2140 (which may also be optional), the UE executes a client application associated with the host application executed by the host computer.

FIG. 22 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 22 will be included in this section. In step 2210 of the method, the host computer provides user data. In an optional substep (not shown) the host computer provides the user data by executing a host application. In step 2220, the host computer initiates a transmission carrying the user data to the UE.

The transmission may pass via the base station, in accordance with the teachings of the embodiments described throughout this disclosure. In step 2230 (which may be optional), the UE receives the user data carried in the transmission.

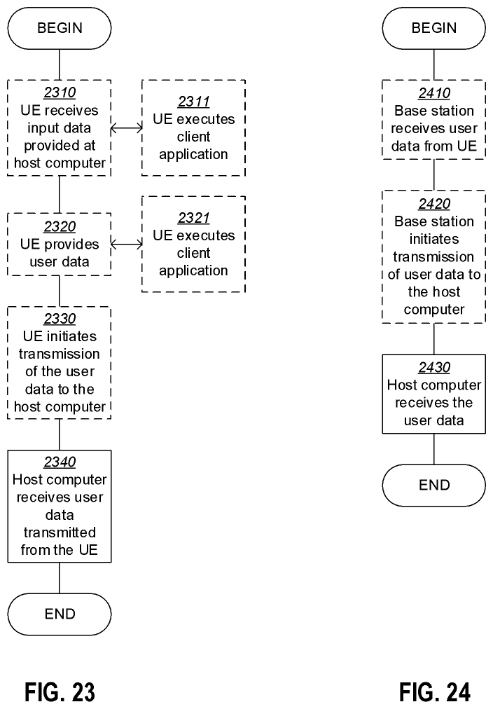

FIG. 23 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 23 will be included in this section. In step 2310 (which may be optional), the UE receives input data provided by the host computer. Additionally or alternatively, in step 2320, the UE provides user data. In substep 2321 (which may be optional) of step 2320, the UE provides the user data by executing a client application. In substep 2311 (which may be optional) of step 2310, the UE executes a client application which provides the user data in reaction to the received input data provided by the host computer. In providing the user data, the executed client application may further consider user input received from the user. Regardless of the specific manner in which the user data was provided, the UE initiates, in substep 2330 (which may be optional), transmission of the user data to the host computer. In step 2340 of the method, the host computer receives the user data transmitted from the UE, in accordance with the teachings of the embodiments described throughout this disclosure.

FIG. 24 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 24 will be included in this section. In step 2410 (which may be optional), in accordance with the teachings of the embodiments described throughout this disclosure, the base station receives user data from the UE. In step 2420 (which may be optional), the base station initiates transmission of the received user data to the host computer. In step 2430 (which may be optional), the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

Hereinafter, the solutions will be further described as follows.

V2X

In Rel-14 and Rel-15, the extensions for the device-to-device work consist of support of V2X communication, which includes any combination of direct communication between vehicles, pedestrians and infrastructure. V2X communication may take advantage of a network (NW) infrastructure, when available, but at least basic V2X connectivity should be possible even in case of lack of coverage. Providing an LTE-based V2X interface may be economically advantageous because of the LTE economies of scale and it may enable tighter integration between communications with the NW infrastructure (V2I), pedestrian (V2P) and other vehicles (V2V), as compared to using a dedicated V2X technology (e.g. IEEE 802.11p).

V2X communications may carry both non-safety and safety information, where each of the applications and services may be associated with specific requirements sets, e.g., in terms of latency, reliability, data rates etc.

There are several different use cases defined for V2X:
V2V (vehicle-to-vehicle): covering LTE-based communication between vehicles, either via the cellular interface (known as Uu) or via the sidelink interface (known as PC5).
V2P (vehicle-to-pedestrian): covering LTE-based communication between a vehicle and a device carried by an individual (e.g. handheld terminal carried by a pedestrian, cyclist, driver or passenger), either via Uu or sidelink (PC5)
V2I/N (vehicle-to-infrastructure/network): covering LTE-based communication between a vehicle and a roadside unit/network. A roadside unit (RSU) is a transportation infrastructure entity (e.g. an entity transmitting speed notifications) that communicates with V2X capable UEs over sidelink (PC5) or over Uu. For V2N, the communication is performed on Uu.

NR V2X Enhancements

3GPP SA1 working group has completed new service requirements for future V2X services in the FS_eV2X. SA1 have identified 25 use cases for advanced V2X services which will be used in 5G (i.e. LTE and NR). Such use cases are categorized into four use case groups: vehicles platooning, extended sensors, advanced driving and remote driving. Direct unicast transmission over sidelink will be needed in some use cases such as platooning, cooperative driving, dynamic ride sharing, etc. For these advanced applications the expected requirements to meet the needed data rate, capacity, reliability, latency, communication range and speed are more stringent. The consolidated requirements for each use case group are captured in TR 22.886.

Sidelink Resource Allocation

There are two different resource allocation (RA) procedures for V2X on sidelink, i.e. NW controlled RA (so called “mode 3” in LTE and “mode 1” in NR) and autonomous RA (so called “mode 4” in LTE and “mode 2” in NR). The transmission resources are selected within a resource pool which is predefined or configured by the network (NW).

With NW controlled RA, the sidelink radio resource for data transmission is scheduled/allocated by the NW. The UE sends sidelink BSR to the NW to inform sidelink data available for transmission in the sidelink buffers associated with the MAC entity, and the NW signals the resource allocation to the UE using DCI. With autonomous RA, each device independently decides which radio resources to use for each transmission based on e.g. sensing.

When performing sensing, the UE decodes the sidelink control information (SCI) transmitted on physical sidelink control channel (PSCCH) from the surrounding UEs, and could know the resources on which the physical sidelink shared channel (PSSCH) is transmitted by these surrounding UEs, and also know the highest priority of the sidelink LCH(s) in the MAC PDU transmitted over PSSCH, which is indicated in the priority field in SCI from the surrounding UEs. The UE also measure PSSCH RSRP and compared it to a threshold, the resource is regarded unoccupied and available for transmission if the measured PSSCH RSRP of the resource is lower than the threshold. The threshold is set taking the priority of both the sensing UE and the sensed UE(s) into account, in a way that the threshold is set higher if the sensing UE has a higher priority than the sensed UE(s), so that the resource is more likely regarded unoccupied and available for the sensing UE's transmission.

Sidelink Control Information

Sidelink control information (SCI) is carried in physical sidelink control channel (PSCCH) and is used to enable decoding of the associated data transmission carried in physical sidelink shared channel (PSSCH). The contents of the SCI in general include the allocated resources, the modulation and coding scheme, HARQ related information (e.g., HARQ process ID, NDI, RV, etc.), the intention to reserve the same resources for a future data transmission. Moreover, for sidelink unicast and groupcast, SCI can further include layer-1 destination ID and potentially source ID as well.

Sidelink Logical Channel Prioritization (LCP)

The LCP procedure is applied when a new sidelink transmission is performed. Each sidelink logical channel (LCH) has an associated priority which is prose per packer priority (PPPP) in LTE and optionally an associated prose per packer reliability (PPPR). In NR, the associated priority and reliability may be derived from the QoS profile of the sidelink radio bearer.

When the MAC entity allocates resources to sidelink LCHs having data available for transmission, it should first select the Layer2 Destination to which the transmission should be performed, based on the highest priority of all the sidelink LCHs belonging to each Layer2 Destination, only LCHs with available data are considered, and the Layer2 Destination having the highest priority is selected. After this, sidelink LCHs belonging to the selected Layer2 Destination are served in decreasing order of priority until either the data for the sidelink logical channel(s) or the sidelink grant is exhausted, whichever comes first.

If there are simultaneous UL and sidelink transmission, prioritization between UL and sidelink transmission is needed. In LTE, if the UL transmission is not for Msg3 or not prioritized by upper layer, the sidelink transmission is prioritized if the value of the highest priority of the sidelink LCH(s) in the MAC PDU is lower than thresSL-TxPrioritization (lower priority value corresponding to higher priority), where thresSL-TxPrioritization is configured by the NW. In NR, it was agreed that the prioritization will consider both UL and sidelink QoS requirements.

If there are simultaneous sidelink transmissions on different frequencies and/or RATs, and the total sidelink Tx power exceeds the maximum allowed Tx power, the UE should decrease the Tx power of the sidelink transmission with the lowest priority, or even drop the transmission. If needed, the procedure is repeated over the non-dropped transmissions, until the maximum allowed Tx power is no more exceeded.

Uplink Logical Channel Prioritization (LCP)

The LCP procedure is applied when a new UL transmission is performed, and a starvation avoidance mechanism is introduced to avoid that all resources are given to the high priority channel(s)/service(s) and low priority channel(s)/service(s) have no chance to be served. To implement this, a variable Bj is maintained for each LCH j and initially set to zero. Bj is incremented by the product prioritisedBitRate (PBR)×T before every instance of the LCP procedure, where T is the time elapsed since Bj was last incremented, if Bj is greater than the bucket size (i.e. PBR×bucketSizeDuration (BSD)), set Bj to the bucket size.

The exact moment(s) when the UE updates Bj between LCP procedures is up to UE implementation, as long as Bj is up to date at the time when a grant is processed by LCP.

When a new transmission is performed, only LCHs with Bj>0 are allocated resources in a decreasing priority order, and decrement Bj by the total size of MAC SDUs served to LCH j (Bj can be negative after this step). If any resource remains, all the LCHs are served in a strict decreasing priority order (regardless of the value of Bj) until either the data for that logical channel or the UL grant is exhausted, whichever comes first.

It was recently agreed that UL like starvation avoidance mechanism is applied to sidelink LCP procedure, but the details are still open. In UL LCP is used to select to which LCH the resource should be allocated. In sidelink, LCP is also used in Layer2 Destination selection, in sensing, in UL/SL prioritization, and SL/SL prioritization. It is not sufficient to just consider starvation avoidance in sidelink LCH selection during resource allocation like in UL, which will lead to mismatch and decrease the benefit of starvation avoidance. Just take Layer2 Destination selection as example, suppose a UE selects to transmit to a Layer2 Destination having the highest priority w/o taking the starvation situation, it could happen that all the sidelink LCH(s) belonging to the selected Layer2 Destination are not starved (e.g. the corresponding Bj<=0), while some sidelink LCH(s) belonging to some other Layer2 Destination(s) are still starved (e.g. the corresponding Bj>0). Clearly in this case starvation will still happen.

The main idea here is to consider starvation avoidance in all sidelink related procedures involving LCP, such as Layer2 Destination selection, prioritization between sidelink new transmission and retransmission, sensing, UL/Sidelink prioritization, the main inventive points include:
Using priority of all the starved LCH(s) in the above procedures when there exist starved LCH(s).
Using priority of all the LCH(s) in the above procedures when there are no starved LCH(s).
Prioritize the starved LCH(s) over the non-starved LCH(s) when there are both starved LCH(s) and non-starved LCH(s).
Rules to determine whether a LCH is starved or not.

The detailed way to implement this is different in the different procedures.

With the methods proposed herein, starvation avoidance is adopted in all the different sidelink procedures involving LCP. The main benefit is that a homogeneous solution is used in sidelink procedures involving LCP, starvation avoidance will not lead to mismatch in these procedures, and the benefit from starvation avoidance could be fully exploited.

This disclosure may be applied to LTE, NR, or any RAT.

The main idea is to consider starvation avoidance in all sidelink related procedures where LCP is used, and prioritize starved LCH(s) over non-starved LCH(s). How this is implemented could be different in different procedures.

In a first aspect, starvation avoidance is considered in Layer2 Destination selection, more specifically, Layer2 Destination to which the transmission should be performed is selected based on:
The highest priority of all the starved sidelink LCH(s) belonging to each Layer2 Destination, if for all the Layer2 Destination(s) there exist LCH(s) that are still starved.
The highest priority of all the sidelink LCH(s) and belonging to each Layer2 Destination, if for all the Layer2 Destination(s) there are no starved LCH(s),
Otherwise only select among Layer2 Destination(s) associated with starved sidelink LCH(s), based on the highest priority of all the starved sidelink LCH(s) belonging to each candidate Layer2 Destination.

In a second aspect, in sidelink, the grant may not indicate whether it is for a new transmission or a retransmission, it is UE to determine whether the grant should be used for a new transmission or a retransmission, a retransmission may be prioritized if the highest priority of the sidelink LCH(s) in the MAC PDU to be retransmitted is higher than that of the sidelink LCH(s) waiting for new transmission, and vice versa. In a second aspect, starvation avoidance could be considered when determining whether the sidelink grant should be used for a new transmission or a retransmission. More specifically:
The grant is used for retransmission if there exist starved LCH(s) in the MAC PDU to be retransmitted while all LCH(s) waiting for new transmission are not starved, and vice versa.
If there exist starved LCH(s) in the MAC PDU to be retransmitted while also starved LCH(s) waiting for new transmission, the highest priority of all the starved LCHs in the MAC PDU to be retransmitted and the highest priority of all the starved LCHs waiting for new transmission are used to determine whether the sidelink grant should be used for the new transmission or the retransmission.
Otherwise (i.e. there does not exist starved LCH(s)), prioritization between new transmission and retransmission is performed as today, i.e. based on the highest priority of all the sidelink LCH(s) waiting for new transmission and that of all the sidelink LCH(s) in the MAC PDU to be retransmitted.

In a third aspect, starvation avoidance is considered in sensing for autonomous RA. To implement this, the priority field in SCI needs to be modified taking the starvation situation into account. More specifically:
The priority field in SCI indicates the highest priority of all the sidelink LCH(s) that are still starved in the MAC PDU, if there exist LCHs that are still starved in the MAC PDU, and includes one bit indicator to indicate that the priority is obtained based on LCH(s) that are still starved (which implicitly implies that there exist LCHs that are still starved).
The priority field in SCI indicates the highest priority of all the sidelink LCH(s) like today, if all the LCHs in the MAC PDU are not starved, and includes one bit indicator to indicate that the priority is obtained based on all the LCH(s) (which implies that all the LCHs are not starved).
Alternatively, the priority field in SCI could indicate both the highest priority of all the starved sidelink LCH(s), and the highest priority of all the non-starved sidelink LCH(s) in the MAC PDU. If there is no LCH that is starved, the corresponding priority value in the priority field is set to a predefined special value, e.g. the highest possible priority value (corresponding to the lowest priority). The special value implies that there is no LCH that is starved (optionally except the LCH(s) with the lowest priority). The same could be adopted If there is no LCH that is not starved.

The way the priority is used in sensing will depend on the situation of both the sensing UE and the sensed UE:
In case both the sensing UE and the sensed UE have starved LCH(s), only the highest priority of the sidelink LCH(s) that are starved are considered in sensing, e.g. in adjusting the PSSCH RSRP threshold.
In case both the sensing UE and the sensed UE do not have starved LCH(s), the highest priority of all the sidelink LCH(s) are considered in sensing, just like today.
In case one among the sensing UE and the sensed UE has starved LCH(s) and the other one does not have starved LCH(s), The priority field in SCI from the UE that does not have starved LCH(s) may be omitted, and a predefined special value, e.g. the highest possible priority value (corresponding to the lowest priority), may be adopted in sensing.

In a fourth aspect, starvation avoidance is considered in UL/sidelink prioritization. More specifically:
The highest priority of all the starved sidelink and the starved UL LCH(s) of the UE is used for UL/sidelink prioritization, if there exists starved LCHs for both UL and sidelink.
The highest priority of all the sidelink and UL LCH(s) of the UE is used for UL/sidelink prioritization, if there are no starved LCHs for both UL and sidelink,
Otherwise, prioritize the link that has starved LCH(s).

Note that the fourth aspect can take both the sidelink new transmission and sidelink retransmission in UL/sidelink prioritization.

In a fifth aspect, starvation avoidance is considered in sidelink/sidelink prioritization. More specifically,
If the total sidelink Tx power exceeds the maximum allowed Tx power, first decrease the Tx power of the non-starved sidelink transmission with the lowest priority, or even drop the transmission. If needed, repeat the procedure over the non-dropped and non-starved transmissions.
If all the non-starved transmissions are dropped and the total sidelink Tx power still exceeds the maximum allowed Tx power, repeat the procedure over the non-dropped and starved transmissions, until the maximum allowed Tx power is no more exceeded.

In a sixth aspect, a LCH could be regarded as not-starved if e.g.:
The current associated Bj is less than (or equal to) zero.
The average Bj over the last M second(s) is less than (or equal to) zero, where M could be configurable.
The average Bj over the last N Bj is less than (or equal to) zero, where each Bj is updated during Layer2 Destination and/or LCH selection for new sidelink transmission, and N could be configurable.
At least P out of the last Q Bj is less than (or equal to) zero, where each Bj is updated during Layer2 Destination and/or LCH selection for new sidelink transmission, and P/Q could be configurable.

Note that in different procedures different criteria may be adopted to determine whether a LCH is starved or not. Further, different Bj values may be kept for UL and SL transmission.

1-117. (canceled)

118. A method in a terminal device, comprising:
Determining whether each of a plurality of Logical Channels (LCHs) to be transmitted over a sidelink is in a starved state; and
selecting at least one of destinations associated with the plurality of LCHs based on whether at least one of the plurality of LCHs is determined to be in the starved state.

119. The method of claim 118, wherein said determining whether each LCH is in the starved state comprises:
determining the LCH with LCH index j to be in the starved state when a variable Bj is greater than zero; wherein Bj is maintained for the LCH with LCH index j and initially set to zero; Bj is incremented by product prioritisedBitRate (PBR)×T before every instance of a Logical Channel Prioritization (LCP) procedure, where prioritisedBitRate (PBR) is a prioritized bit rate and T is time elapsed since Bj was last incremented, and if Bj is greater than a bucket size, Bj is set to the bucket size.

120. The method of claim 118, wherein said determining whether each LCH is in the starved state comprises:
determining the LCH to be in the starved state when a scheduled data rate of the LCH is lower than or equal to a predefined data rate for the LCH.

121. The method of claim 120, wherein the scheduled data rate comprises:
a current scheduled data rate,
an average scheduled data rate over a last time period,
an average of a number of last updated scheduled data rates, or
each of P out of Q last updated scheduled data rates, where P and Q are configurable integers.

122. The method of claim 118, wherein said selecting comprises:
selecting, when at least one of the plurality of LCHs is determined to be in the starved state, from at least one destination associated with the at least one LCH, a destination having a highest destination priority, wherein a destination priority of each of the at least one destination is a highest LCH priority among LCH priorities of the respective LCHs associated with that destination that are determined to be in the starved state.

123. The method of claim 118, wherein said selecting comprising:
selecting, when none of the plurality of LCHs is determined to be in the starved state, from destinations associated with the plurality of LCHs, a destination having a highest destination priority, wherein a destination priority of each destination is a highest LCH priority among LCH priorities of the respective LCHs associated with that destination.

124. A method in a terminal device, comprising:
determining, for each of a plurality of Logical Channel (LCHs) to be transmitted over a sidelink, whether the LCH is in a starved state; and
selecting at least one of destinations associated with the plurality of LCHs based on whether at least one of the plurality of LCHs is determined to be in the starved state.

125. The method of claim 124, wherein said determining, for each of the plurality of LCHs, whether the LCH is in the starved state comprises:
determining the LCH with LCH index j to be in the starved state when a variable Bj is greater than zero; wherein Bj is maintained for the LCH with LCH index j and initially set to zero; Bj is incremented by product prioritisedBitRate (PBR)×T before every instance of a Logical Channel Prioritization (LCP) procedure, where prioritisedBitRate (PBR) is a prioritized bit rate and T is time elapsed since Bj was last incremented, and if Bj is greater than a bucket size, Bj is set to the bucket size.

126. The method of claim 124, wherein said determining, for each of the plurality of LCHs, whether the LCH is in the starved state comprises:
determining the LCH to be in the starved state when a scheduled data rate of the LCH is lower than or equal to a predefined data rate for the LCH.

127. The method of claim 126, wherein the scheduled data rate comprises:
a current scheduled data rate,
an average scheduled data rate over a last time period,
an average of a number of last updated scheduled data rates, or
each of P out of Q last updated scheduled data rates, where P and Q are configurable integers.

128. The method of claim 124, wherein said selecting comprises:
selecting, when at least one of the plurality of LCHs is determined to be in the starved state, from at least one destination associated with the at least one LCH, a destination having a highest destination priority, wherein a destination priority of each of the at least one destination is a highest LCH priority among LCH priorities of the respective LCHs associated with that destination that are determined to be in the starved state.

129. The method of claim 124, wherein said selecting comprising:
selecting, when none of the plurality of LCHs is determined to be in the starved state, from destinations associated with the plurality of LCHs, a destination having a highest destination priority, wherein a destination priority of each destination is a highest LCH priority among LCH priorities of the respective LCHs associated with that destination.

130. A terminal device, comprising a processor and a memory, the memory comprising instructions executable by the processor whereby the terminal device is operative to:
determine, for each of a plurality of Logical Channels (LCHs) to be transmitted over a sidelink, whether the LCH is in a starved state; and
select at least one of destinations associated with the plurality of LCHs based on whether at least one of the plurality of LCHs is determined to be in the starved state.

131. The terminal device of claim 130, wherein to determine, for each of the plurality of LCHs, whether the LCH is in the starved state comprises:
determining the LCH with LCH index j to be in the starved state when a variable Bj is greater than zero; wherein Bj is maintained for the LCH with LCH index j and initially set to zero; Bj is incremented by product prioritisedBitRate (PBR)×T before every instance of a Logical Channel Prioritization (LCP) procedure, where prioritisedBitRate (PBR) is a prioritized bit rate and T is time elapsed since Bj was last incremented, and if Bj is greater than a bucket size, Bj is set to the bucket size.

132. The terminal device of claim 130, wherein to determine, for each of the plurality of LCHs, whether the LCH is in the starved state comprises:
determining the LCH to be in the starved state when a scheduled data rate of the LCH is lower than or equal to a predefined data rate for the LCH.

133. The terminal device of claim 132, wherein the scheduled data rate comprises:
a current scheduled data rate,
an average scheduled data rate over a last time period,
an average of a number of last updated scheduled data rates, or
each of P out of Q last updated scheduled data rates, where P and Q are configurable integers.

134. The terminal device of claim 130, wherein to select comprises:
selecting, when at least one of the plurality of LCHs is determined to be in the starved state, from at least one destination associated with the at least one LCH, a destination having a highest destination priority, wherein a destination priority of each of the at least one destination is a highest LCH priority among LCH priorities of the respective LCHs associated with that destination that are determined to be in the starved state.

135. The terminal device of claim 130, wherein to select comprises:
selecting, when none of the plurality of LCHs is determined to be in the starved state, from destinations associated with the plurality of LCHs, a destination having a highest destination priority, wherein a destination priority of each destination is a highest LCH priority among LCH priorities of the respective LCHs associated with that destination.
